(19) United States
(12) Patent Application Publication
(10) Pub. No.: US 2014/0351366 A1
(43) Pub. Date: Nov. 27, 2014

(54) INFORMATION PROCESSING SYSTEM AND METHOD FOR CONTROLLING SAME

(71) Applicant: FUJITSU LIMITED, Kawasaki-shi (JP)

(72) Inventors: Munenori MAEDA, Yokohama (JP); Toshihiro Ozawa, Yokohama (JP)

(73) Assignee: FUJITSU LIMITED, Kawasaki-shi (JP)

(21) Appl. No.: 14/279,655

(22) Filed: May 16, 2014

(30) Foreign Application Priority Data
May 22, 2013 (JP) 2013-108028

(51) Int. Cl. H04L 29/08

(52) U.S. Cl. CPC H04L 67/1097
USPC 709/215

(57) ABSTRACT

An information processing system includes a first storage unit configured to store first divided data indicating divided time-series data, a second storage unit configured to store second divided data indicating divided time-series data divided at a time that is different from a time at which the first divided data is divided, and an processor that executes a procedure including, when a reproduction time is designated for the time-series data, reading and outputting divided data divided at a time just before the reproduction time from among the first divided data and the second divided data stored in the first storage unit and the second storage unit.

### CROSS-REFERENCE TO RELATED APPLICATION

This application is based upon and claims the benefit of priority of the prior Japanese Patent Application No. 2013-108028, filed on May 22, 2013, the entire contents of which are incorporated herein by reference.

### FIELD

The embodiments discussed herein are related to a storage system.

### BACKGROUND

The market of real-time analysis processes (RTAPs) directed to, for example, sensor information and various logs has been enlarged, and it has been important to efficiently accumulate and use time series data used as inputs. When, for example, an information gathering/analyzing service for time series data is performed on a cloud, pieces of input information and pieces of log information from many sensors are assembled, and vast amounts of data is accumulated. All or some pieces of the accumulated data are reproduced on an as-needed basis.

Time series data is different from ordinary data in the sense that time series data is a data row in which an order is defined, and that the entirety of the time series data (hereinafter referred to as a stream), in addition to individual pieces of the data, becomes a processing object. For example, a process is performed wherein an accumulated stream is designated and pieces of data ranging from one moment to another moment are read in turn. Each individual piece of data of a stream will hereinafter be referred to as stream data.

To accumulate a large flow of stream data in a storage, writing throughput is maximized by performing writing using a data size suitable for a network characteristic and a storage characteristic. The network characteristic is, for example, the characteristic of a TCP/IP (Transmission Control Protocol/Internet Protocol) communication network. The storage characteristic is, for example, the input-output characteristic of a hard disk. In particular, to store pieces of stream data each having a small size in a storage apparatus, throughput is enhanced by collecting a plurality of pieces of stream data into a partial data row and by storing this partial data row in the storage apparatus. The partial data row that includes a plurality of pieces of stream data will hereinafter be referred to as a block.

The following is a known reproducing apparatus that reproduces video contents. The reproducing apparatus includes video content means to save (store) video streams. Each video stream includes a plurality of scenes, each described by a corresponding scene characteristic. The reproducing apparatus includes selecting means for selecting a scene characteristic describing the video content of a scene that a user wishes to watch. The reproducing apparatus also includes means for comparing a selected scene characteristic with scene characteristics of a saved video stream so as to identify one or more scenes whose scene characteristic is similar to the selected scene characteristic. Moreover, the reproducing apparatus includes means for reproducing at least one scene having a scene characteristic identified as being similar to the selected scene characteristic.

The technologies described in the following documents are known.
Japanese Laid-open Patent Publication No. 2011-41299 International Publication Pamphlet No. WO 2006/011270

### SUMMARY

According to an aspect of the embodiment, an information processing system includes a first storage unit configured to store first divided data indicating divided time-series data, a second storage unit configured to store second divided data indicating divided time-series data divided at a time that is different from a time at which the first divided data is divided, and an processor that executes a procedure including, when a reproduction time is designated for the time-series data, reading and outputting divided data divided at a time just before the reproduction time from among the first divided data and the second divided data stored in the first storage unit and the second storage unit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates the storing and the reproducing of a stream in accordance with the embodiment;

FIG. 2 illustrates multiplexing of stream data;

FIG. 3 illustrates a relationship between sequences with reference to partition positions between blocks when data is triplicated;

FIG. 4 illustrates a changing of a redundancy degree in accordance with importance;

FIGS. 5A and 5B illustrate that excessive redundancy can be decreased;

FIG. 6 illustrates the functional block diagram of an information processing system;

FIG. 7 illustrates the configuration of an information processing apparatus in relation to a writing process of stream data to a storage apparatus;

FIG. 8 illustrates the configuration of an information processing apparatus in relation to a process of reading stream data from a storage apparatus.

FIG. 9 illustrates an exemplary configuration of management information;

FIG. 10 illustrates an exemplary situation in which data is triplicated and saved for data redundancy;

FIG. 11 illustrates a stream termination;

FIG. 12 illustrates an operation flow diagram for block generation and a writing process for writing to a storage apparatus in accordance with embodiment 1;

FIGS. 13A and 13B illustrate a writing process 1 in accordance with embodiment 1;

FIG. 14 illustrates the operation flow diagram of the writing process 1 in accordance with embodiment 1;

FIG. 15 illustrates a writing process 2 in accordance with embodiment 1;

FIG. 16 illustrates the operation flow diagram of the writing process 2 in accordance with embodiment 1;

FIG. 17 illustrates an operation flow diagram for a situation in which a controlling unit in accordance with embodiment 1 detects termination data in stream data;

FIG. 18 illustrates a writing process 3 in accordance with embodiment 1;

FIG. 19 illustrates the operation flow diagram of the writing process 3 in accordance with embodiment 1;

FIG. 20 illustrates the operation flow diagram of a process of increasing a redundancy degree;

FIG. 21 illustrates the operation flow diagram of a process of decreasing a redundancy degree;

FIG. 22 illustrates the operation flow diagram of a redundancy reestablishment process;

FIG. 23 illustrates examples of a plurality of blocks that include data present in a section that is a target of redundancy reestablishment;

FIG. 24 illustrates an operation flow diagram for data reproducing;

FIG. 25 illustrates exemplary control variables for a writing process in accordance with embodiment 2;

FIG. 26 illustrates an operation flow diagram for block generation and a writing process for writing to a storage apparatus in accordance with embodiment 2;

FIG. 27 illustrates the operation flow diagram of a writing process 4 in accordance with embodiment 2;

FIG. 28 illustrates the operation flow diagram of a writing process 5 in accordance with embodiment 2;

FIG. 29 illustrates an operation flow diagram for a situation in which a controlling unit in accordance with embodiment 2 detects termination data in stream data;

FIG. 30 illustrates the operation flow diagram of a writing process 6 in accordance with embodiment 2;

FIG. 31 illustrates an operation flow diagram for an offset-position changing in accordance with embodiment 2;

FIG. 32 illustrates the operation flow diagram of a changing process 1 in accordance with embodiment 2;

FIG. 33 illustrates the operation flow diagram of a changing process 2 in accordance with embodiment 2; and

FIG. 34 illustrates an exemplary hardware configuration of an information processing apparatus.

### DESCRIPTION OF EMBODIMENTS

In a process of reproducing stream data, random-access reproduction is performed wherein a particular time is designated and data is reproduced starting from the designated time point. In particular, in a random-access function, a designated time is defined as a start time, and data rows are sequentially obtained and reproduced in chronological order. For example, when the random-access reproduction is performed in a distributed storage system, data reading from a storage apparatus is performed for each block that includes a piece of data associated with a designated reproduction start time. From among the pieces of data in the read block, the pieces extending from the piece at the head of the block to the piece just before the designated reproduction start time are skipped, and the reproduction process starts with the piece of data associated with the reproduction start time. In this case, in the random-access reproduction, when a piece of data associated with a reproduction start time is present in the middle of a block, useless data reading is occurred.

The information processing system in accordance with the present embodiment may improve the read performance in random-access reproduction of a stream.

### Embodiment 1

Time-series data is, for example, lifetime health management data (Personal Health Record) of an individual. One way to separately manage health statuses of a person is to record, on an as-needed basis, various pieces of data produced by, for example, a medical institution, a pharmacy, a health-related company, and a health information measuring instrument. Saved information generally includes: height and weight; blood type; vital information (e.g., pulse, breathing, blood pressure, and body temperature); allergies; side effects; anamnestic history and symptoms; hospital visits, examinations, and medical care; prescriptions and medications; chief physician comments; care plan; diet information; exercise information; medical checkups; and insurance-related information.

To predict and analyze a possible or future disease or disorder from the vital information in real time, time-series data within a desired range needs to be quickly accessed from among saved long-term data in accordance with the focus of the analysis.

When an analysis is performed in parallel processes, a replica of data may be placed at another location to prevent access conflict with the same data.

Treatment history (e.g., medication history) can be important evidence for verification of a medical error, and hence the data reliability of the treatment history is important. Not all of the treatment records need to have high reliability, and, in view of the cost that is needed to save data, it is advantageous to consider that data reliabilities change hour by hour on a case-by-case basis.

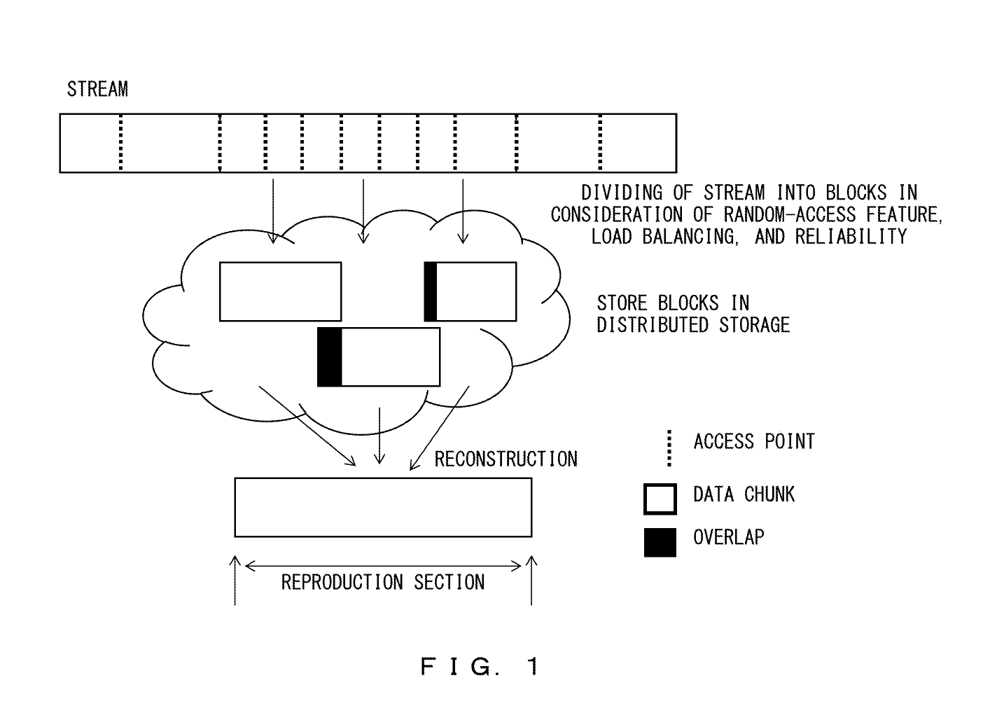

FIG. 1 illustrates the storing and the reproducing of a stream in accordance with the present embodiment. The stream is divided into a plurality of blocks in consideration of a random-access feature, load balancing, and reliability. The blocks obtained via the dividing may include an overlap. The blocks obtained via the dividing are distributed and stored in a distributed storage. In the reproducing of a stored stream, a block that includes data designated by a reproduction section is obtained from the distributed storage, and an overlap is deleted from the plurality of obtained blocks to reconstruct the stream for the reproduction section.

In storage systems of recent years (e.g., NoSQL, represented by a distributed KVS (Key-Value Storage)), data replicas are located in a plurality of nodes. This decreases the rate of occurrence of missing data that would be caused by, for example, a disk failure and enables the reading of data from the replicas located in the plurality of nodes, so that load balancing can be achieved for access. In this way, locating replicas of a block in a distributed manner achieves high reliability and high-speed access.

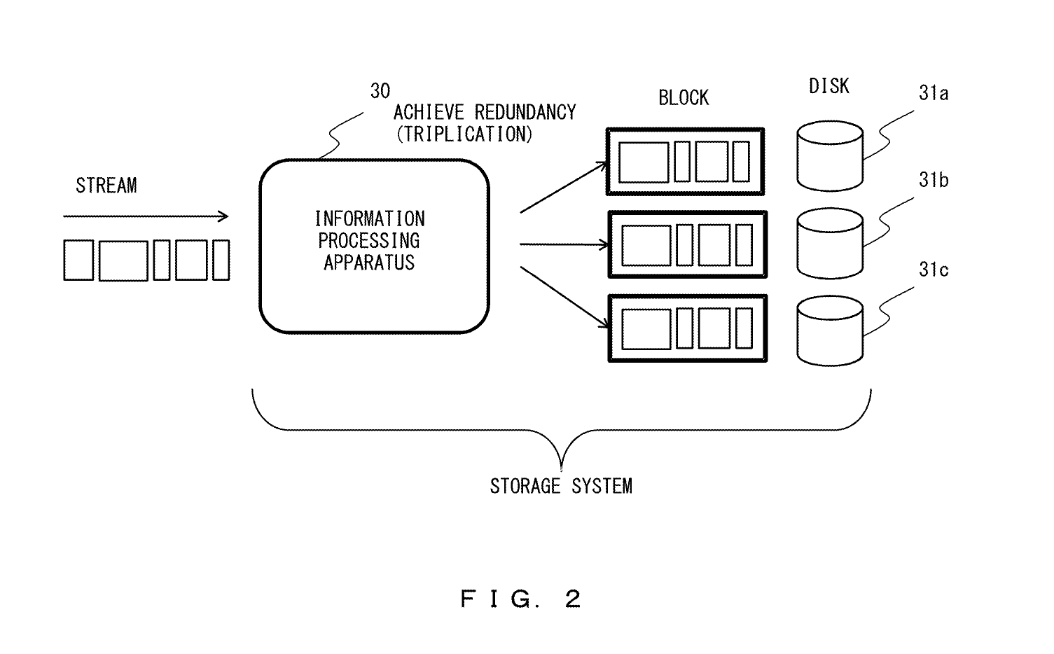

FIG. 2 illustrates multiplexing of stream data. As depicted in FIG. 2, “data is multiplexed” means that data for the same time (section) is replicated and the original data and the replica data are stored in different storage apparatuses (e.g., disks). The value indicating the number of storage apparatuses that each store apiece of data obtained by distributing data for the same time (section) is a redundancy degree.

In FIG. 2, upon receipt of a stream, an information processing apparatus 30 generates three replica blocks from the received stream and stores each of these blocks in a different one of disks 31a, 31b, and 31c. In the example of FIG. 2, the redundancy degree is 3.

To distinguish from each other pieces of data which are each stored in a storage apparatus as a result of making one stream redundant (replication), a data group stored in each storage apparatus will hereinafter be expressed as “one sequence”. That is, data of a certain sequence refers to data stored in a storage apparatus that corresponds to the sequence.

Pieces of data stored in different storage apparatuses are stored on a block-by-block basis. A block, which is a collection of a plurality of pieces of stream data included in a particular range of the time series of one stream, is a smallest data unit that is read for reproducing.

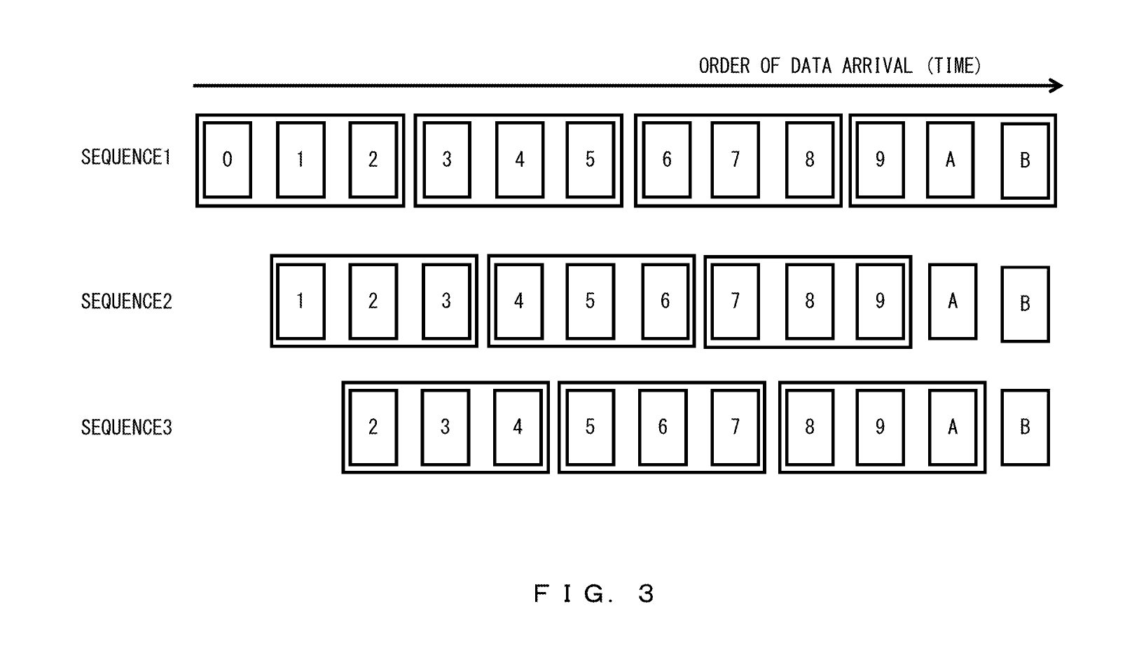

In the present embodiment, partition positions between blocks stored in different storage apparatuses are different for each sequence. FIG. 3 illustrates a relationship between sequences with reference to partition positions between blocks for triplicated data in the embodiment.

In FIG. 3, a horizontal axis indicates an order in which pieces of data arrive (time). The time of arrival herein refers to a time when data arrives at an apparatus that replicates a stream (information processing apparatus 30 in FIG. 2), but the time may be a time when each piece of data of the stream is measured or observed. The blocks of three sequences 1, 2, and 3 are partitioned at different times.

In comparison with the partition positions between the blocks of the sequence 1, the partition positions of the sequence 2 deviate backward by ⅓ of a block on a time axis. In comparison with the partition positions between the blocks of the sequence 1, the partition positions of the sequence 3 deviate backward by ⅔ of a block on the time axis.

In the reading of data, the data of any of the sequences 1, 2, and 3 may be used. Hence, in an example of triplication as in FIG. 2, intervals between readable starting positions become ⅓ of the original intervals, thereby making an execution time for the process of random-access reproduction ⅓ the execution time specific in a situation in which only sequence 1 is used.

Pieces of data of the sequences 1, 2, and 3 are stored in different storage apparatuses, thereby eliminating a latency that would occur when one storage apparatus is intensively accessed. That is, in parallel with data reading from the sequence 1, data can be read from the sequence 2, thereby enhancing reading speed. Moreover, data reliability is improved, and load balancing is achieved for accessing.

In stream data, data importance and access frequency may be different for each time interval. Important data and frequently accessed data may desirably have a redundancy degree that is higher than usual to enhance reliability and access performances.

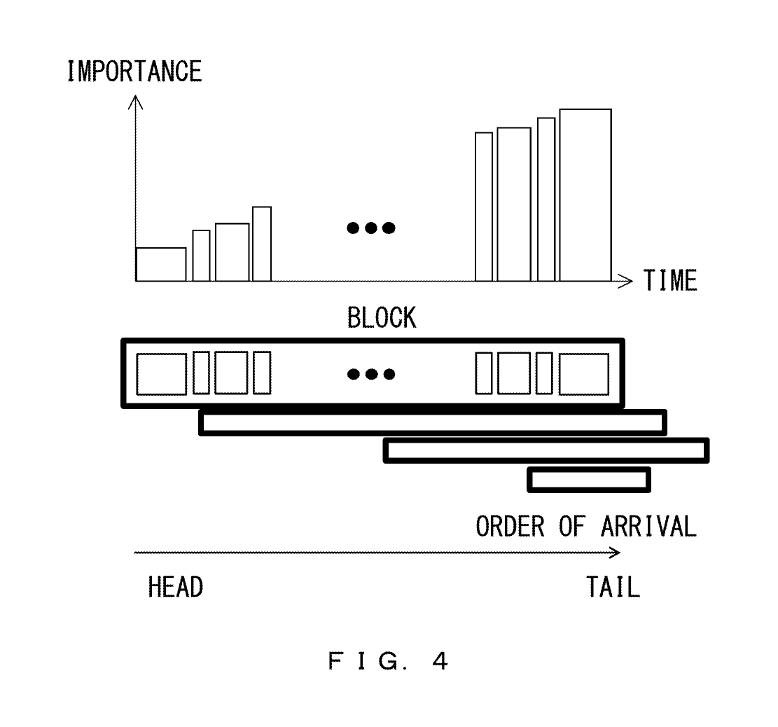

FIG. 4 illustrates a changing of a redundancy degree in accordance with importance. In a bar graph in an upper portion of FIG. 4, a horizontal axis indicates times, and a vertical axis indicates importance or access frequency. A lower portion of FIG. 4 indicates the redundancy degree of stream data that depends on the importance or the access frequency indicated in the bar graph in the upper portion of FIG. 4. In FIG. 4, the redundancy of stream data that corresponds to a time when importance (or access frequency) becomes the highest is 4. That is, the redundancy degree becomes high for data of a high importance (or frequently accessed data).

As described above, in the embodiment, to change the redundancy degree in accordance with the importance or access frequency of data, overlapped sections of blocks are added or deleted. Making the size of blocks unfixed may decrease excessive redundancy.

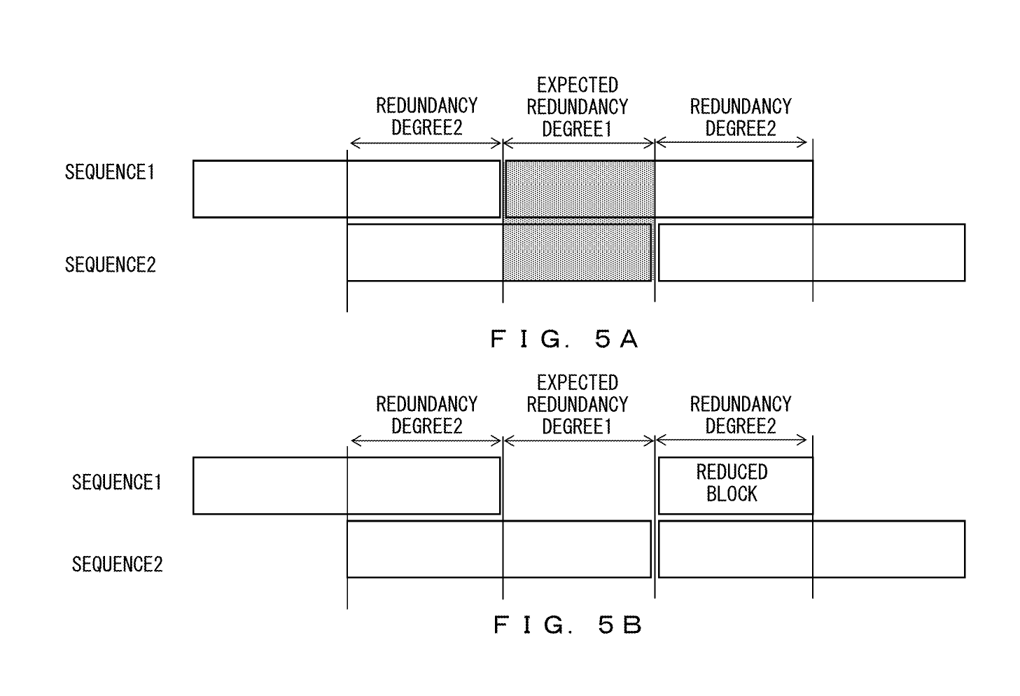

FIGS. 5A and 5B illustrate that excessive redundancy can be decreased in the embodiment. A redundancy degree suitable for the importance of data will hereinafter be referred to as an expected redundancy degree.

FIG. 5A depicts an example in which excessive redundancy occurs due to a fixed block size. Even in the case of a section wherein a redundancy of one block is sufficient (a portion with an expected redundancy degree of 1), if the redundancy degree is 2, then this is excessive redundancy.

FIG. 5B depicts an example in which excessive redundancy is decreased by changing a block length. In FIG. 5B, excessive redundancy is avoided by decreasing the size of a block of the sequence 1 that includes data with an expected redundancy degree of 1.

The importance of stream data is determined using various methods. As an example, a method is available wherein, in accordance with a characteristic of time-series data, data obtained in the daytime has a high importance and data obtained in the nighttime has a low importance. An access frequency unique to stream data may be used as the importance of the stream data.

In addition to the triplication in FIG. 2, a higher redundancy degree may be applied for only the portion of data that has a high importance. In this case, while ensuring that a redundancy degree of 3 at the lowest is maintained for all data, a higher multiplicity is achievable.

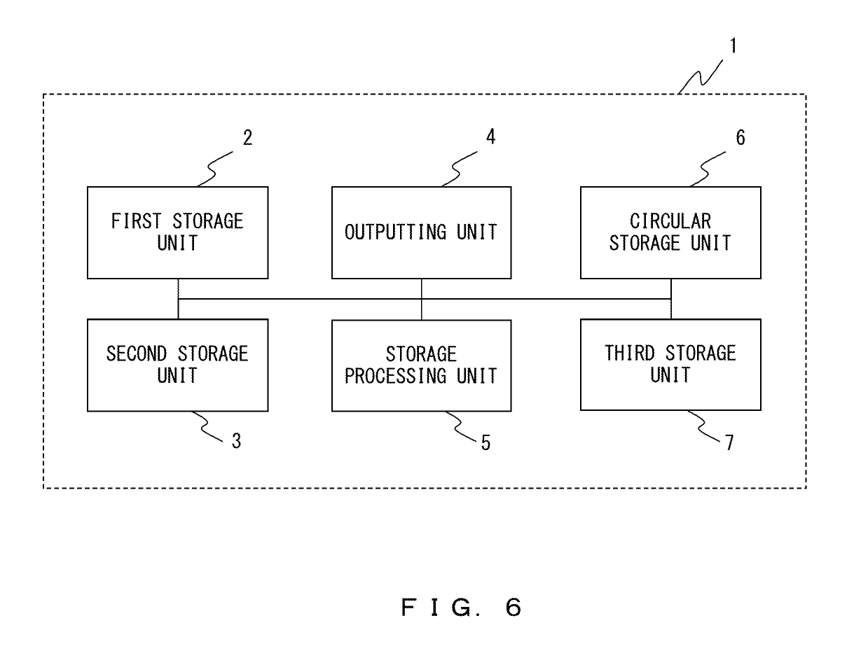

FIG. 6 illustrates the functional block diagram of an information processing system in accordance with the embodiment. An information processing system 1 includes a first storage unit 2, a second storage unit 3, an outputting unit 4, a storage processing unit 5, a circular storage unit 6, and a third storage unit 7.

The first storage unit 2 stores first divided data indicating divided time-series data.

The second storage unit 3 stores second divided data indicating divided time-series data divided at a time that is different from a time at which the first divided data is divided.

When a reproduction time is designated for the time-series data, the outputting unit 4 reads and outputs divided data divided at a time just before the reproduction time from among the first divided data and the second divided data stored in the first storage unit 2 and the second storage unit 3. When a reproduction time is designated for the time-series data, the outputting unit 4 also reads and outputs divided data divided at a time just before the reproduction time from among the first divided data, the second divided data, and third divided data stored in the first storage unit 2, the second storage unit 3, and the third storage unit 7.

The storage processing unit 5 stores in the first storage unit 2 the first divided data, which is generated by dividing the time-series data, and stores in the second storage unit 3 the second divided data, which is generated by dividing the time-series data at a time that is different from a time at which the first divided data is divided. The storage processing unit 5 stores pieces of the time-series data in consecutive regions in the circular storage unit 6 in chronological order. When storing a piece of time-series data in a region associated with the first storage unit 2 from among the plurality of regions in the circular storage unit 6, the storage processing unit 5 stores in the first storage unit 2 the first divided data, which is generated by replicating pieces of data stored in the plurality of regions in the circular storage unit 6. When storing a piece of time-series data in a region associated with the second storage unit 3 from among the plurality of regions in the circular storage unit 6, the storage processing unit 5 stores in the second storage unit 3 the second divided data, which is generated by replicating pieces of data stored in the plurality of regions in the circular storage unit 6. When storing a piece of data indicating a termination of the time-series data in a region in the circular storage unit 6, the storage processing unit 5 stores in the first storage unit 2 apiece of data that has not been stored in the first storage unit 2 from among the pieces of data stored in the plurality of regions in the circular storage unit 6, and stores in the second storage unit 3 a piece of data that has not been stored in the second storage unit 3 from among the pieces of data stored in the plurality of regions in the circular storage unit 6. In accordance with the importance of the time-series data, the storage processing unit 5 stores in the third storage unit 7 the third divided data, which is generated by dividing the time-series data at a time that is different from the times at which the first divided data and the second divided data are divided.

The circular storage unit 6 includes a plurality of regions in which information is stored and which are arranged in a logically circulating formation.

The third storage unit 7 stores the third divided data, which is generated by diving the time-series data at a time that is different from the times at which the first divided data and the second divided data are divided.

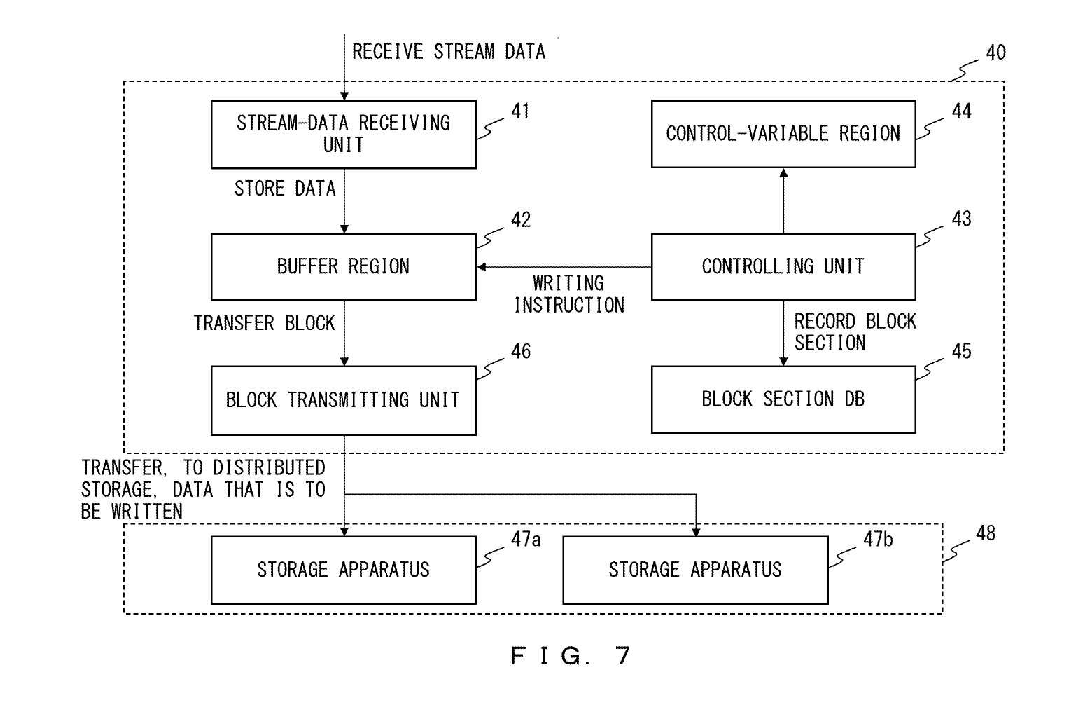

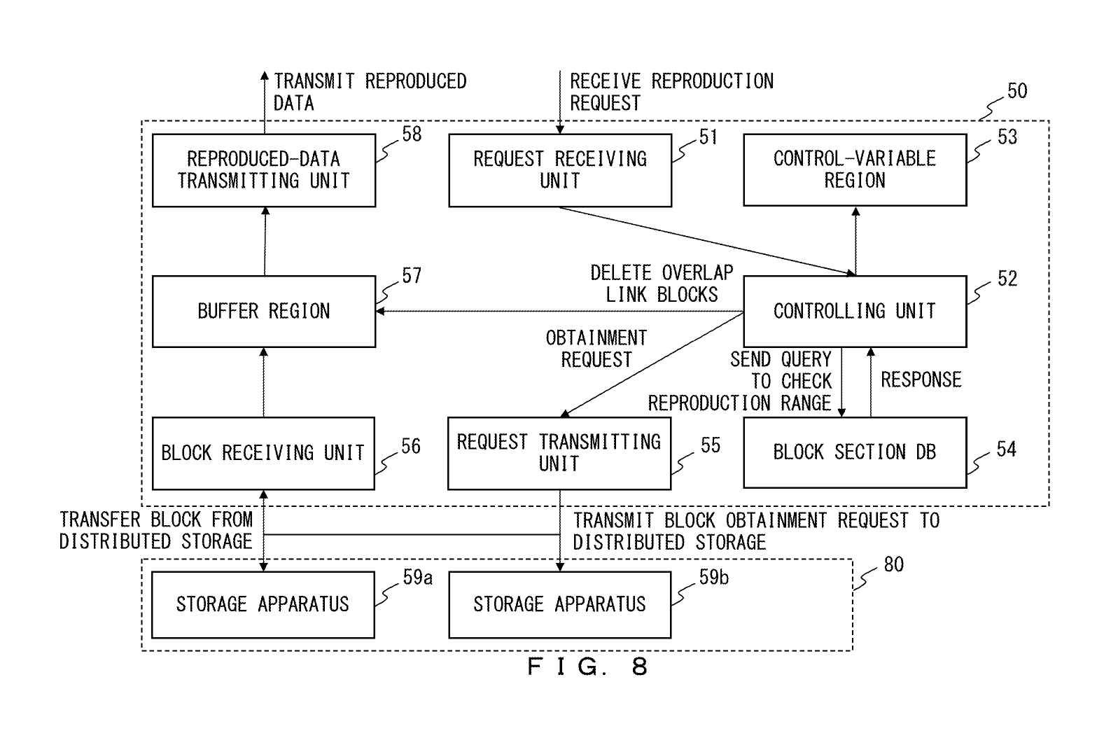

FIGS. 7 and 8 depict the configuration of an information processing system in accordance with the embodiment. FIG. 7 illustrates the configuration of an information processing apparatus in relation to a process of writing stream data to a storage apparatus.

An information processing apparatus 40 receives, replicates, and writes stream data to a distributed storage 48 that includes a plurality of storage apparatuses 47a and 47b. A unit of writing is a unit of block that includes a plurality of pieces of stream data. To achieve the writing process, the information processing apparatus 40 includes a stream-data receiving unit 41, a buffer region 42, a controlling unit 43, a control-variable region 44, a block-section database 45 (a database will hereinafter be referred to as a “DB”), and a block transmitting unit 46.

The storage apparatuses 47a and 47b are examples of the first storage unit 2, the second storage unit 3, and the third storage unit 7. The stream-data receiving unit 41, the controlling unit 43, and the block transmitting unit 46 are examples of the storage processing unit 4. The buffer region 42 is an example of the circular storage unit 5.

The stream-data receiving unit 41 receives and stores stream data in the buffer region 42.

The buffer region 42 is a working space used to collect a plurality of pieces of stream data into a block.

The controlling unit 43 generates a block by collecting individual pieces of stream data stored in the buffer region 42 and transmits the block to the storage apparatuses 47a and 47b via the block transmitting unit 46. In this case, the pieces of stream data stored in the buffer region 42 are replicated and transmitted to the different storage apparatuses, i.e., the storage apparatuses 47a and 47b. That is, stream data is made to be redundant. A process wherein the controlling unit 43 transmits stream data to the storage apparatuses 47a and 47b may hereinafter be referred to as a writing process.

The control-variable region 44 is a region in which control-variable information used in the writing process performed by the controlling unit 43 is stored.

Management information related to a block generated by the controlling unit 43 is stored in the block-section DB 45. Management information includes information on a time (or an obtained time) for a chronologically initial piece of stream data and on a time (or an obtained time) for a chronologically last piece of stream data from among the plurality of pieces of stream data included in a block. The time for the initial piece of stream data included in a block and the time for the last piece of stream data included in the block may hereinafter be referred to as a start time and a finish time of the block, respectively. Management information also stores information indicating in which of the storage apparatuses 47a or 47b a block is stored, i.e., information indicating which sequence the block belongs to.

The block transmitting unit 46 transmits blocks generated by the controlling unit 43 to the storage apparatuses 47a and 47b.

The storage apparatuses 47a and 47b, which are connected to the information processing apparatus 40, store received blocks. Both the storage apparatuses 47a and 47b will hereinafter be simply referred to as a “storage apparatus 47” when these apparatuses do not need to be distinguished from each other. The storage apparatuses 47 may be connected to the information processing apparatus 40 via a network such as a NAS (Network Attached Storage) or a SAN (Storage Area Network) or may be connected to the information processing apparatus 40 via a bus such as a PCI (Peripheral Component Interconnect) Express. The storage apparatuses 47 may be included in the information processing apparatus 40. FIG. 7 depicts two storage apparatuses, as the redundancy degree is 2, but a greater redundancy may be achieved for the storage apparatuses 47 included in the distributed storage 48 in accordance with the multiplicity of data.

Next, descriptions will be given of a process of reading stream data from the storage apparatus. FIG. 8 illustrates the configuration of the information processing apparatus in relation to a process of reading stream data from the storage apparatus.

An information processing apparatus 50 receives a reproduction request of a stream data, and obtains, from storage apparatuses 59a and 59b included in a distributed storage 80, a block that includes the piece of stream data included in a reading target range designated by the received reproduction request. Then, the information processing apparatus 50 generates, from the obtained block, the piece of stream data included in the reading target range and transmits the generated piece of stream data to the source of the reproduction request. To achieve the reading process, the information processing apparatus 50 includes a request receiving unit 51, a controlling unit 52, a control-variable region 53, a block section DB 54, a request transmitting unit 55, a block receiving unit 56, a buffer region 57, and a reproduced-data transmitting unit 58.

The storage apparatuses 59a and 59b are examples of the first storage unit 2, the second storage unit 3, and the third storage unit 7. The controlling unit 52 is an example of the outputting unit 4.

The request receiving unit 51 receives, from a terminal connected to the information processing apparatus 50, a reproduction request of a stream data, and transfers the received reproduction request to the controlling unit 52. The reproduction request includes a set of a start time and a finish time designated as a reproduction request range, and a pieces of stream data between the start time and the finish time are defined as targets to be read.

Upon receipt of the reproduction request, the controlling unit 52 retrieves, from the block section DB 54, blocks that include the piece of stream data included in the reproduction request range. Then, the controlling unit 52 transmits an obtainment request for the retrieved blocks to the storage apparatuses 59a and 59b via the request transmitting unit 55. When the requested blocks from the storage apparatuses 59a and 59b, which have received the obtainment request for the blocks, are stored in the buffer region 57, the controlling unit 52 deletes an overlap of the blocks or joins the blocks, thereby generating a reproduction stream that is a stream within the reproduction range. Then, the controlling unit 52 transmits the generated reproduction stream via a reproduced-data transmitting unit 58 to a terminal that is the source of the reproduction request.

The control-variable region 53 is a region in which control-variable information used in the reading process performed by the controlling unit 52 is stored.

The block section DB 54 is identical with the block-section DB 45 in FIG. 7.

The request transmitting unit 55 transmits to the distributed storage 80 the block obtainment request from the controlling unit 52.

The distributed storage 80 receives the block obtainment request and transmits a block to the block receiving unit 56. The block receiving unit 56 stores the received block in the buffer region 57.

The buffer region 57 is a region that has stored therein a block received via the block receiving unit 56 from the storage apparatus 59a or 59b which has received a block obtainment request. The buffer region 57 is used by the controlling unit 52 to generate a reproduction stream.

The reproduced-data transmitting unit 58 transmits the reproduction stream generated by the controlling unit 52 to the source of the reproduction request.

Note that the distributed storage 80 corresponds to the distributed storage 48 described with reference to FIG. 7 and that the storage apparatuses 59a and 59b correspond to the storage apparatuses 47a and 47b that store a block in FIG. 7. That is, as with the storage apparatuses 47a and 47b, the storage apparatuses 59a and 59b store a block. Both the storage apparatuses 59a and 59b will hereinafter be simply referred to as a “storage apparatus 59” when these apparatuses do not need to be distinguished from each other.

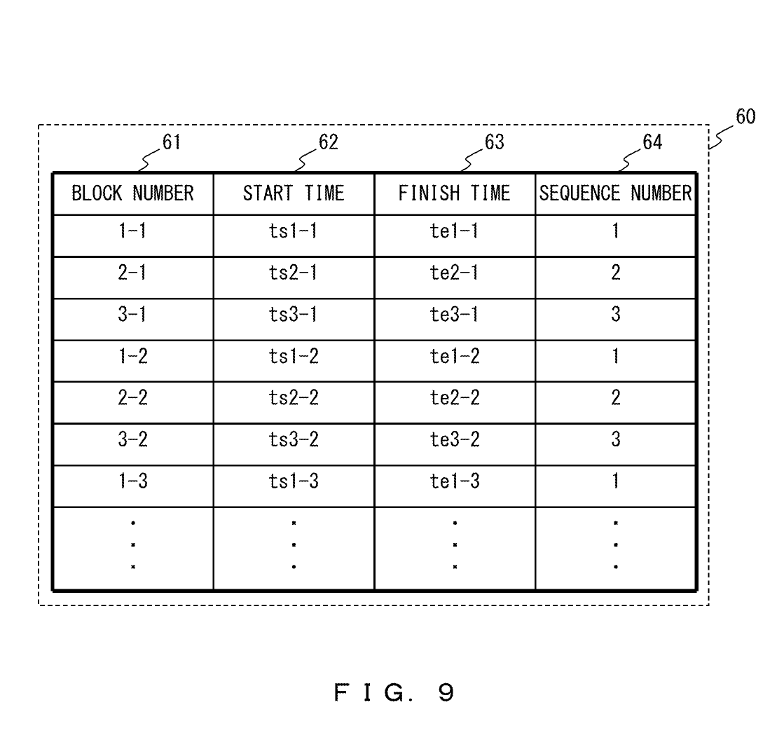

The following will describe block management information stored in the block-section DBs 45 and 54. FIG. 9 illustrates an exemplary configuration of management information.

Management information 60 includes data fields of block numbers 61, start times 62, finish times 63, and sequence numbers 64.

The block number 61 is directed to unique identification of a block stored in the storage apparatus 47. The start time 62 is information indicating a start time of a block having a block number 61. The finish time 63 is information indicating a finish time of a block having a block number 61. The sequence number 64 is information indicating the sequence of a block indicated by a block number 61. In other words, the sequence number 64 is information for identifying of a storage apparatus that stores a block.

Next, descriptions will be given of a data redundancy achieving process in detail. In the embodiment, a circular buffer is used as one mechanism to store, in the storage apparatuses 47, stream data that has been made to be redundant. The circular buffer (ring buffer) is an example of the buffer region 42 or 57.

Upon receipt of stream data, the stream-data receiving unit 41 stores the received data in the circular buffer. Then, as described above with reference to FIG. 3, the controlling unit 43 writes, to the individual redundant storage apparatuses 47, the data stored in the circular buffer in a manner such that partition positions between blocks are different for each sequence.

The circular buffer includes a plurality of regions (elements), each of which can have apiece of stream data stored therein. The regions (elements) are distinguished from each other within the circular buffer using uniquely assigned indices (subscripts). In the embodiment, the indices are integers uniquely associated with regions (elements), where 0 is the lowest. The number of regions in the circular buffer with which indices are associated (number of elements) will hereinafter be referred to as a buffer size.

In the circular buffer, regions in which data is stored are specified by specifying the indices, and a value assigned to designate an index may be greater than the buffer size. When a value assigned to designate an index is greater than the buffer size, an index that is the remainder of the designated index divided by the buffer size is designated. Hence, the circular buffer may be obtained by logically linking the ends of a linear buffer.

In the embodiment, when one block includes N pieces of stream data, the circular buffer can store N (N is an integer) pieces of stream data. Assume that N is the buffer size. Individual pieces of data stored in the circular buffer are stored in order of reception and in ascending order of index of the buffer. When a piece of data is stored in a region in the circular buffer having the last index (N−1 in this embodiment), a piece of data subsequently received is stored in a region in the circular buffer having the initial index (0 in this embodiment). The sizes of individual regions (elements) in the circular buffer may be fixed or may be variable in accordance with the size of data to be stored. That is, pieces of data stored in the circular buffer may each have a different size.

When stream data are stored in a region having predetermined indices in the circular buffer, or when termination data of a stream is stored in the circular buffer, the controlling unit 43 performs a process of writing data in the circular buffer to the storage apparatuses 47.

First, descriptions will be given of a process of writing data in the circular buffer to the storage apparatuses 47 when stream data are stored in a region having predetermined indices in the circular buffer.

Indices that trigger the process of writing stream data are associated with the individual redundant storage apparatuses 47, i.e., associated with sequences, and are arranged in the circular buffer with equal intervals.

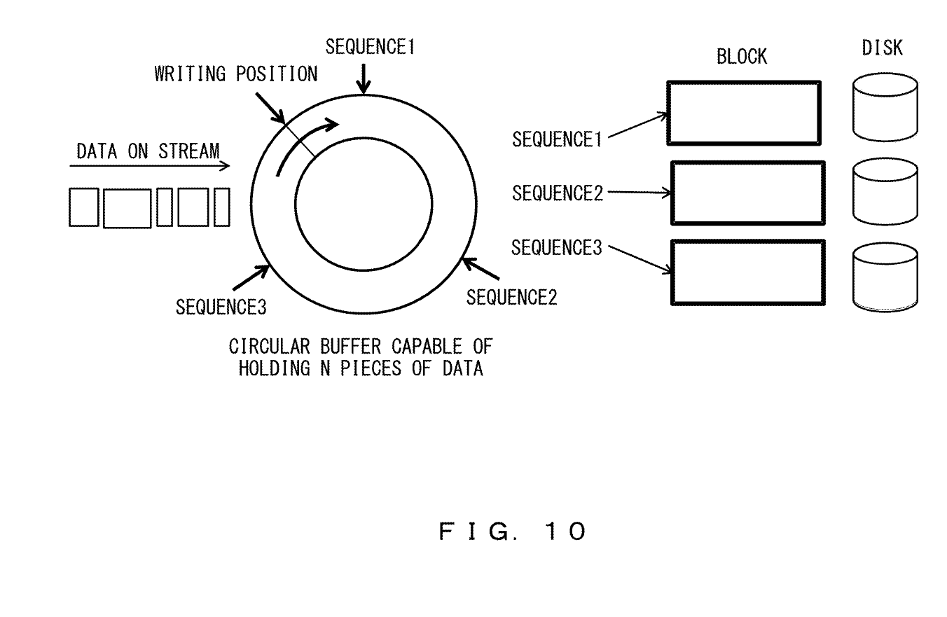

FIG. 10 illustrates an exemplary situation in which data is triplicated and saved for data redundancy in accordance with the embodiment.

Under a condition in which data is triplicated and stored, where a data group stored in each storage apparatus 47 is one sequence, when a piece of data is stored at position with index (N/3−1), (2N/3−1), or N−1 within the circular buffer, the writing process is performed for each sequence. The position of the index where the writing process corresponding to each sequence is performed may hereinafter be referred to as offset positions. The offset positions are arranged with equal intervals in the circular buffer, and hence partition positions between blocks deviate by equal intervals between the sequences.

An offset position is indicated as (N*x/K−1) (x=1, 2, . . . , K), where N indicates the number of pieces of data stored in one block, K (K is an integer) indicates a redundancy degree, and indices within the circular buffer range from 0 to N−1. In the example of FIG. 10, the offset positions are indicated as (N/3−1), (2N/3−1), and N−1 because redundancy degree=3.

Three sequences are present in the case of triplicated data, and, for descriptions, the sequences are indicated as sequences 1, 2, and 3. When data is stored in the region with the index (N/3−1) within the circular buffer, the controlling unit 43 defines data stored in the circular buffer as one block and stores this block in the storage apparatus 47 that corresponds to sequence 1. When data is stored in the region with the index (2N/3−1) within the circular buffer, the controlling unit 43 defines data stored in the circular buffer as one block and stores this block in the storage apparatus 47 that corresponds to sequence 2. When data is stored in the region with the index N−1 within the circular buffer, the controlling unit 43 defines data stored in the circular buffer as one block and stores this block in the storage apparatus 47 that corresponds to sequence 3. Note that the content of the buffer is not erased at each timing at which the controlling unit 43 stores, in a storage apparatus 47 that corresponds to a sequence, data included in the buffer.

When termination data of a stream is stored in the circulation buffer, the controlling unit 43 writes the data within the circulation buffer to the storage apparatus 47.

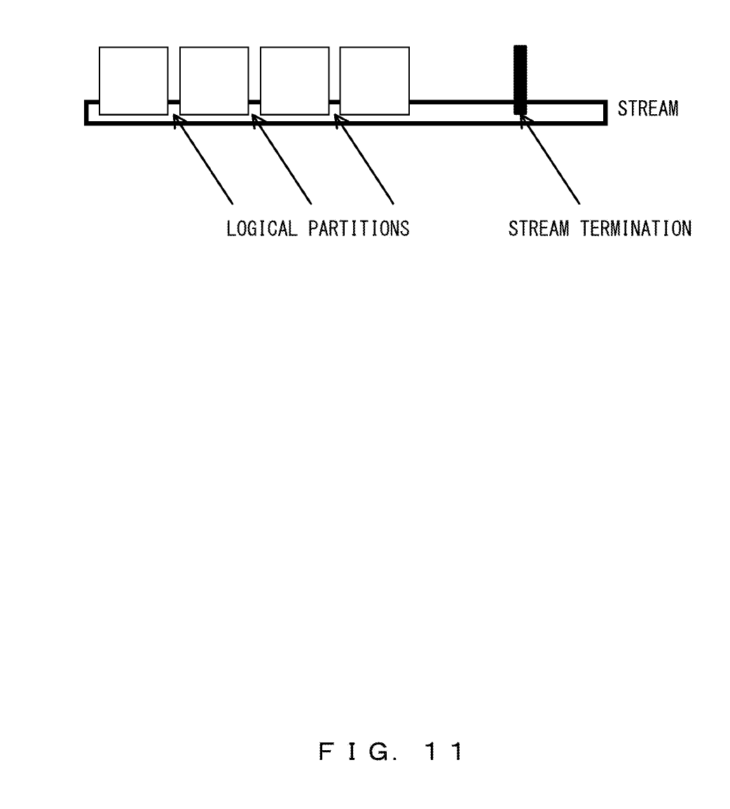

Stream data includes termination data that indicates a termination of a stream. FIG. 11 illustrates a stream termination. A stream is a logically partitioned data row, and a special partition called a stream termination is present at an end of the stream. Data that indicates such a special partition in a stream is termination data. As an example, termination data may have a unique attribute that indicates a partition or may have a particular size that indicates a partition.

Next, descriptions will be given of operations of the writing process performed by the controlling unit 43 to write data from the circulation buffer to the storage apparatus 47.

The writing process performed by the controlling unit 43 includes three patterns distinguished from each other in view of the timing of writing and the state of the buffer at the time of the writing process. The three patterns are writing processes 1, 2, and 3.

Timings at which the controlling unit 43 writes blocks are a time point when received stream data is stored at an offset position in the circular buffer and a time point when the controlling unit 43 senses a termination of the stream data.

The states of the circular buffer at the time of the writing process include a state wherein data is stored in all of the regions (elements) in the circular buffer, and a state wherein data is stored in some of the regions (elements) in the circular buffer. The state wherein data is stored in some of the regions (elements) in the circular buffer indicates the states ranging from a state wherein no data is stored in the circular buffer to a state wherein data is stored for the first time at a region with the last index within the circular buffer, i.e., indicates a situation in which the circular buffer includes at least one index at which data has never been stored. Once data is stored in the region with the last index, a state continues wherein data is stored in all of the regions (elements).

Irrespective of the timing of writing, the writing process 1 is performed when the state of the circular buffer at the time of the writing process satisfies the state wherein data is stored in some of the regions (elements). In the writing process 1, the controlling unit 43 generates, as one block, data ranging from the initial index (0 in the embodiment) to the index at which data is lastly stored, and stores the generated block in a storage apparatus 47. That is, when writing is performed under a condition in which data is stored at an offset position, the controlling unit 43 first generates, as one block, data stored in the regions ranging from the initial index to the offset position. The controlling unit 43 stores the generated block in the storage apparatus 47 associated with the offset position. When sensing termination data, the controlling unit 43 stores, in the storage apparatus 47, data stored in the regions ranging from the initial index to the index at which the termination data is stored. Pieces of stream data are arranged in the block generated by the controlling unit 43 in an order in which these pieces are stored in the circular buffer.

The writing process 2 is performed under a condition in which data is stored in all of the regions (elements) in the circular buffer at the time point when received stream data is stored at an offset position in the circular buffer. In the writing process 2, the controlling unit 43 sequentially adds pieces of data within the circular buffer to one block (called a block A, for descriptions) in ascending order of index starting from the index that follows an offset position for an object sequence for writing. When the last index of the circular buffer is reached, the flow returns to the initial index, and pieces of data ranging from the initial index to the offset position are added to the block A in ascending order of index. Then, the controlling unit 43 writes the generated block (block A) to the storage apparatus 47.

The writing process 3 is performed under a condition in which the index at which the termination data is stored is lower than an offset position for a object sequence for writing at the time point when the controlling unit 43 senses a termination data. Alternatively, the writing process 3 is performed under a condition in which, at the time point when the controlling unit 43 senses a termination data, the index at which the data is stored is higher than an offset position for a object sequence for writing and data has been stored once in all of the elements of the circular buffer.

In the writing process 3, the controlling unit 43 sequentially adds, to one block (hereinafter referred to as a block B, for description), pieces of data within the circulation buffer in ascending order of index starting from the piece at the position with the index that follows an offset position for a object sequence for writing. When the last index of the circular buffer is reached, the flow returns to the initial index, and the pieces of data ranging from the initial index to the storage position are added, in ascending order of index, to the block to which data has been added until the last index has been reached (block B). Then, the controlling unit 43 writes the generated block (block B) to the storage apparatus 47.

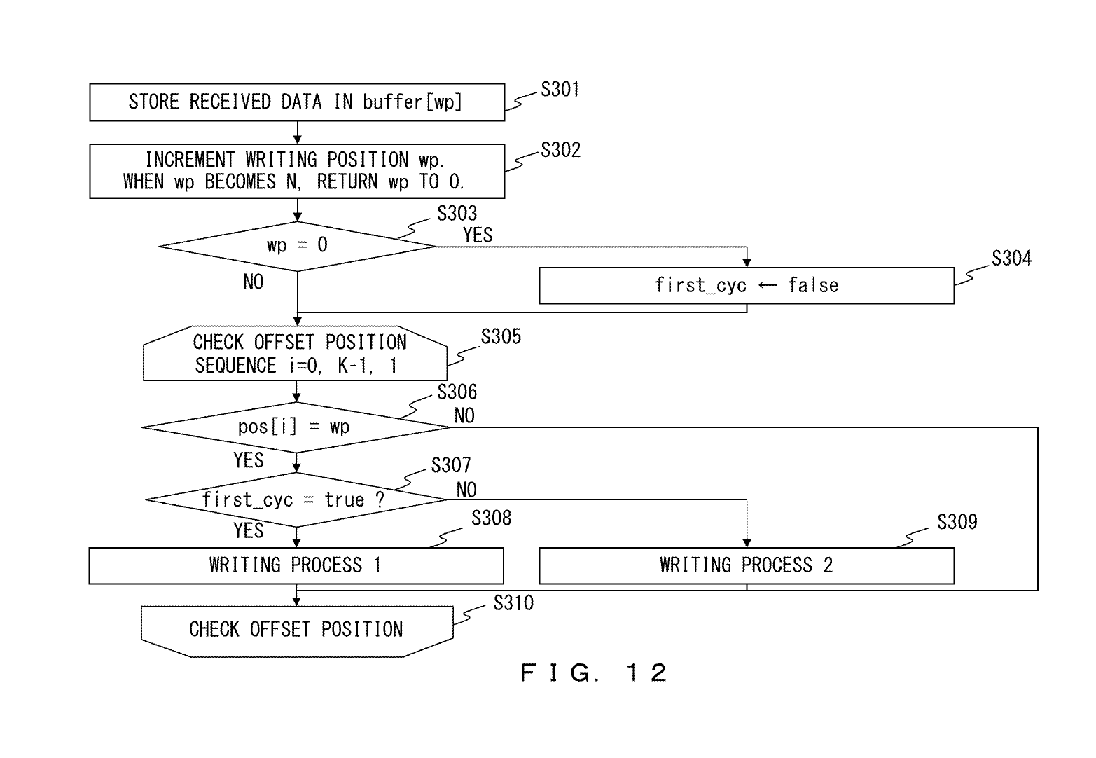

FIG. 12 illustrates an operation flow diagram for block generation and a writing process for writing to a storage apparatus 47.

In FIG. 12, N indicates the buffer size of a circular buffer; buffer[ ], the circular buffer; K, a redundancy degree; pos[ ], an array wherein the value of an offset position for each sequence plus 1 is stored (which may hereinafter be referred to as an offset array). In addition, wp indicates a variable indicating the index of a storage position within the circular buffer at which data is stored by the stream-data receiving unit 41, and first_cyc indicates a variable that indicates whether information has been stored at all of the indices of the circular buffer at least once.

buffer[ ] indicates the circular buffer using an array of element counts N, and a subscript of buffer[ ] corresponds to the aforementioned index of the circular buffer. Pieces of received stream data are stored at elements of the array buffer[ ]. In the following descriptions, a simple expression of “index” refers to an index in the circular buffer, i.e., a subscript of buffer[ ], and, to indicate a subscript of any other array, the name of the array is specifically designated and the mark “subscript” is added. Each element of the array buffer [ ] may have a variable length in accordance with stored data.

wp is a variable indicating the index of a storage position within the circular buffer at which data is stored by the stream-data receiving unit 41. That is, the stream-data receiving unit 41 stores received stream data at a position with the index indicated by wp within the circular buffer. A storage position within the circular buffer at which data is stored by the stream-data receiving unit 41 may hereinafter be simply referred to as a storage position wp.

The array pos[ ] is an array wherein the value of an offset position for each sequence plus 1 is stored. The value of an offset position for the sequence 1 plus 1 is stored in pos[0001]. The values of respective offset positions of the sequences 2, 3, . . . , K plus 1 are respectively stored in pos[0002], pos[0003], . . . , pos[K−1]. As an example, in the case of x=1, 2, . . . , K−1, pos[x−1]=(N*x/K) and pos[K−1]=0.

first_cyc is a variable that indicates whether stream data has been stored at all of the indices of the circular buffer at least once, i.e., a variable indicating whether a process of storing stream data in the circular buffer performed by the controlling unit 43 is in a first cycle. A value first_cyc that indicates true means that the process of storing stream data in the circular buffer performed by the controlling unit 43 is in the first cycle. first_cyc may hereinafter be referred to as a first-cycle flag first_cyc.

In a variable initialization process, the controlling unit 43 assigns 0 to wp and true to first_cyc. The controlling unit 43 stores, in each element of pos[ ], the value of an offset position for each sequence plus 1.

After the variable initialization process, the controlling unit 43 performs the processes of S301-S310 every time stream data is received. One loop of S301-S310 is a process performed every time the stream-data receiving unit 41 receives one piece of stream data, and is also a process wherein stream data is stored in one region (element) in the circular buffer. Every time the loop is completed, the index where the piece of stream data is stored in the circular buffer is incremented. When a loop is finished in which data is stored at the last index of the circular buffer, a loop follows in which data is stored at the initial index.

Upon receipt of stream data, the controlling unit stores the received data in buffer[wp] (S301). As described above, wp is a variable indicating an index at which stream data is stored within the circular buffer. Next, the controlling unit 43 increments the value wp (S302).

In S302, when the value wp becomes N (buffer size) after the value wp is incremented, the controlling unit 43 assigns 0 to wp. This process indicates an operation wherein pieces of stream data are stored at indices starting from the initial index of the circular buffer and, when a piece of data is stored at the last index, the next piece of data is stored at the initial index.

Next, the controlling unit 43 determines whether the value wp is 0 (S303). The fact that the value wp is 0 (Yes in S303) means that data has been stored at all of the indices of the circular buffer at least once, causing the controlling unit 43 to set the value first_cyc to false (S304). The process then transfers to an offset-position checking process indicated by S305-S310. In S303, when the value wp is not 0 (No in S303), the process transfers to the offset-position checking process indicated by S305-S310.

In the offset-position checking indicated by the loop of S305-S310, the loop is a process performed once for every sequence, i.e., the process is repeated for all of the sequences. That is, the processes (loop) of S305-S310 are repeated during the period ranging from 0 to K−1 of the variable that indicates a sequence, and the value i is incremented at the end of the loop.

First, the controlling unit 43 determines whether 0≦i≦K−1 is satisfied (S305). When 0≦i≦K−1, the controlling unit 43 performs the processes of S306-S309. When i>K−1, the loop ends, i.e., the processes end.

In S306, the controlling unit 43 determines whether pos[i] is equal to wp. As described above, pos[i] is the value of an offset position for the sequence i plus 1, and wp is a value obtained as a result of incrementing in S302 the value indicating a storage position within the circular buffer at which received data is stored in S301. That is, in S306, it is determined whether the storage position within the circular buffer at which data is stored in S301 is an offset position for the sequence i.

When it is determined in S306 that the pos[i] is different from wp (No in S306), the process transfers to S310. When it is determined in S306 that pos[i] is equal to wp (Yes in S306), the controlling unit 43 determines which of true or false the value first_cyc is (S307). When first_cyc is true (Yes in S307), the process transfers to the writing process 1 (S308). When first_cyc is false in S307 (No in S307), the process transfers to the writing process 2 (S309).

The following will describe the writing process 1 in detail. As described above, the writing process 1 is a writing process performed during the period from the moment when an initially received piece of stream data is stored in the circular buffer to the moment when apiece of data is stored at the last index of the circular buffer for the first time.

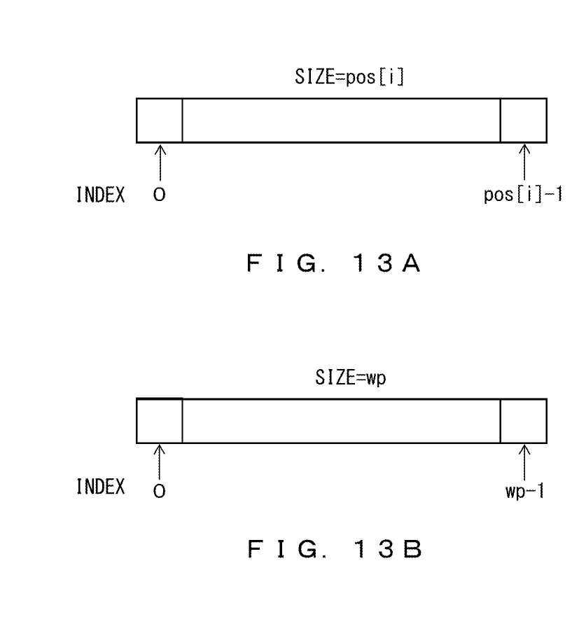

FIGS. 13A and 13B illustrate the writing process 1. FIG. 13A depicts an example of the writing process 1 performed when stream data is written at an offset position within the circular buffer under a condition in which the circular buffer includes an element at which data has never been stored. FIG. 13B depicts an example of the writing process 1 performed when a termination of stream data is sensed under a condition in which the circular buffer includes an element at which data has never been stored. In FIG. 13A, the pieces of data ranging from index “0” to pos [i]−1 in the circular buffer are collected into a block. FIG. 13A indicates the block size pos[i]. In FIG. 13B, the pieces of data ranging from index “0” to wp−1 in the circular buffer are collected into a block. FIG. 13B indicates the block size wp.

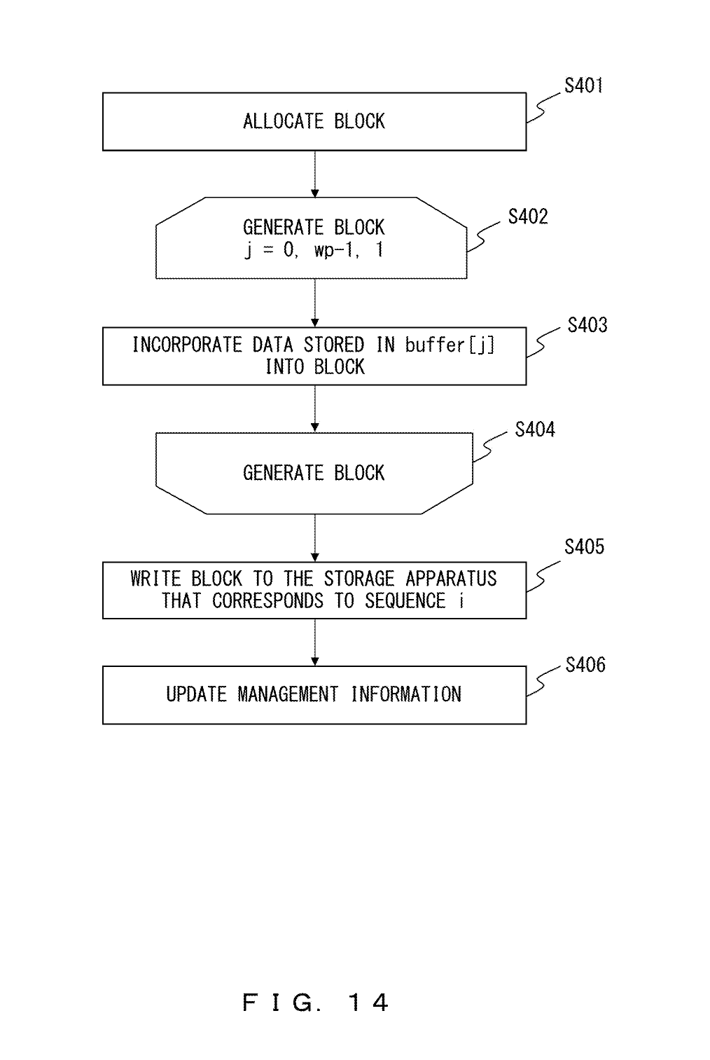

FIG. 14 illustrates the operation flow diagram of the writing process 1. In a loop process of S402-S404, the controlling unit 43 performs a process of collecting the pieces of data ranging from index “0” to the storage position (wp−1) within the circular buffer into one block.

First, the controlling unit 43 allocates an object block for writing and also assigns a block number to the object block (S401). In S401, the object block for writing does not include stream data. Block numbers are identification information for unique identification of blocks.

The process loop of S402-S404 indicates processes of incorporating stream data within the circular buffer into the block with the block number assigned in S401.

First, the controlling unit 43 assigns 0 to a variable j that designates an index of data to be incorporated into the object block for writing from among the stream data stored in the circular buffer (S402). The controlling unit 43 incorporates data stored in buffer[j] into the block that has the block number assigned in S401 (S403). The controlling unit 43 increments the value j and determines whether j satisfies 0≦j≦wp−1 (S402). When 0≦j≦wp−1, the process loops to perform S403 again.

When j<0 or j≧wp in S402, the loop ends, then the process transfers to S405.

In S405, the controlling unit 43 writes the object block for writing generated in S401-S404 to the storage apparatus 47 that corresponds to the sequence i.

The controlling unit 43 stores information on the written block in the management information 60 of the block-section DB 45 (S406). That is, the controlling unit 43 generates a new record in the management information 60 and respectively stores the block number, the start time, the finish time, and the sequence i of the block written in S405 in the block number 61, the start time 62, the finish time 63, and the sequence number 64 of the created record.

The following will describe the writing process 2 in detail. As described above, the writing process 2 is an example of the writing process performed when a data stream received by the stream-data receiving unit 41 is stored at an offset position in the circular buffer after data have been stored at all of the indices of the circular buffer at least once.

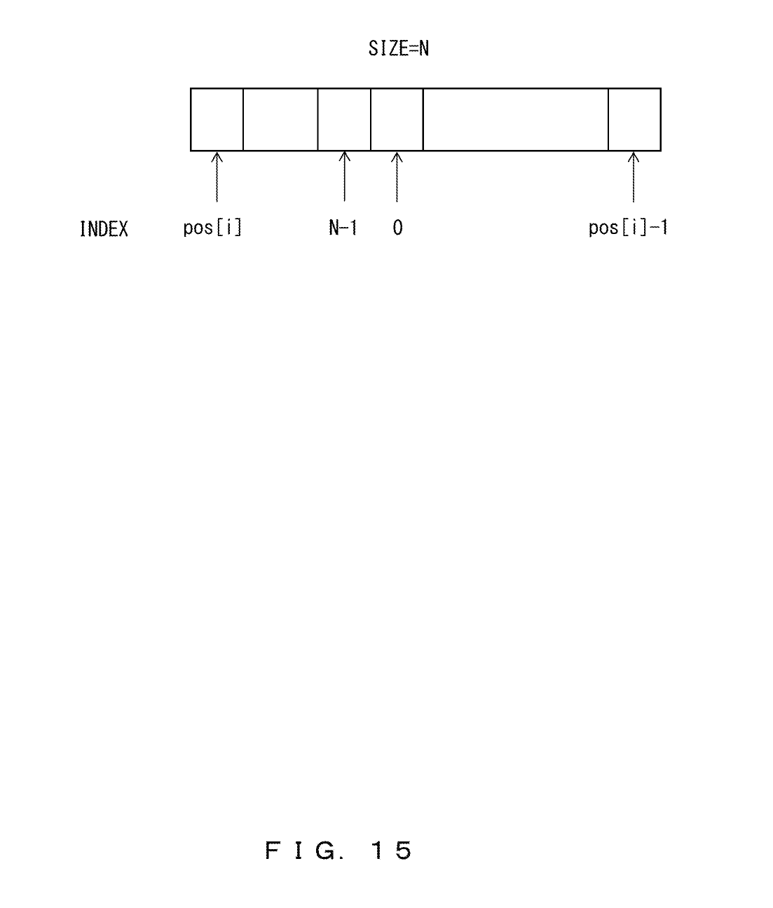

FIG. 15 illustrates the writing process 2. In the writing process 2, the controlling unit 43 performs a block generating process wherein the pieces of data designated by indices pos[i] to N−1 of the circular buffer are collected in ascending order of index, and wherein, when the index is reached to N, 0 is assigned to the index and the pieces of data ranging from 0 to pos[i]−1 are collected in an ascending order. Note that the block size is N.

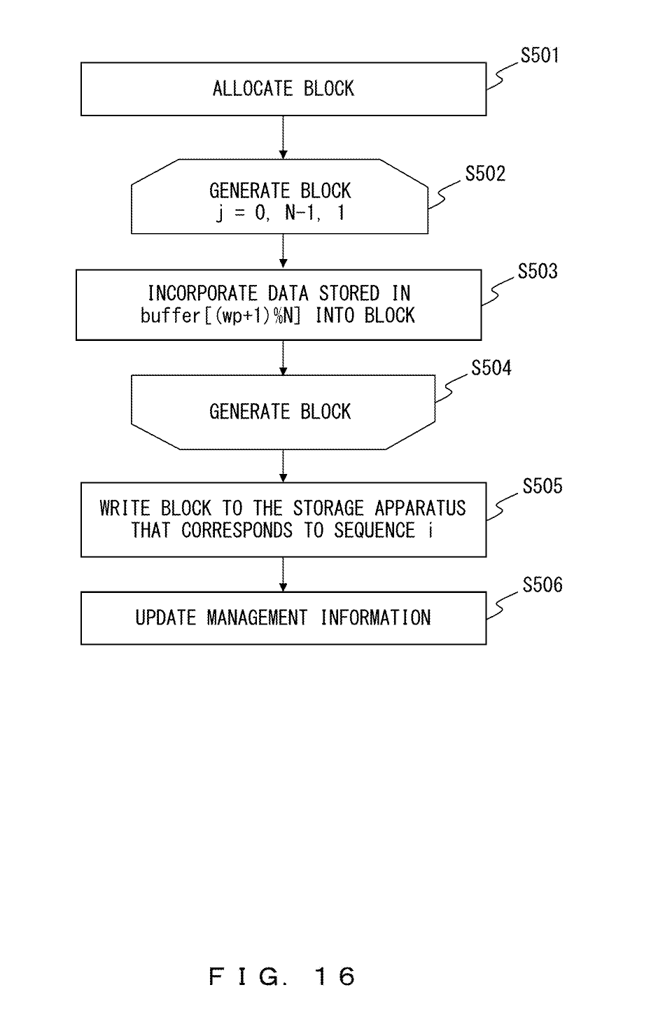

FIG. 16 illustrates the operation flow diagram of the writing process 2. In a loop process of S502-S504, the controlling unit 43 performs a process of collecting pieces of data within the circular buffer into one block.

First, the controlling unit 43 allocates an object block for writing and also assigns a block number to the object block (S501). In S501, the object block for writing does not include stream data.

The process loop of S502-S504 indicates a process of incorporating pieces of stream data within the circular buffer into the block that has the block number assigned in S501. Pieces of stream data for earlier times within the circular buffer are earlier incorporated into the block. Hence, pieces of stream data for earlier times are located at more anterior portions of the block, i.e., the piece for the earliest time is located at the head of the block.

First, the controlling unit 43 assigns 0 to a variable j that designates an index of the buffer for which the writing process is performed (S502). The controlling unit 43 incorporates data stored in buffer [(wp+j) % N] into the block that has the index assigned in S501 (S503), where (wp+j) % N indicates the remainder of (wp+j) divided by N. The controlling unit 43 increments the value j and determines whether j satisfies 0≦j≦N−1 (S502). When 0≦j≦N−1, the process loops to perform S503 again. When j<0 or j≧N in S502, the loop ends, then the process transfers to S505.

In S505, the controlling unit 43 writes the object block for writing generated in S501-S504 to the storage apparatus 47 that corresponds to the sequence i.

The controlling unit 43 stores information on the written block in the management information 60 of the block-section DB 45 (S506). That is, the controlling unit 43 generates a new record in the management information 60 and respectively stores the block number, the start time, the finish time, and the sequence i of the block written in S505 in the block number 61, the start time 62, the finish time 63, and the sequence number 64 of the created record.

The following will describe operations performed when the controlling unit 43 detects termination data in stream data. Detecting that stream data is termination data, the controlling unit 43 stores, in any of the storage apparatuses 47, pieces of data that have not been stored in any storage apparatus 47 from among the pieces of data stored in the circular buffer at the moment when the termination data is put in the circular buffer.

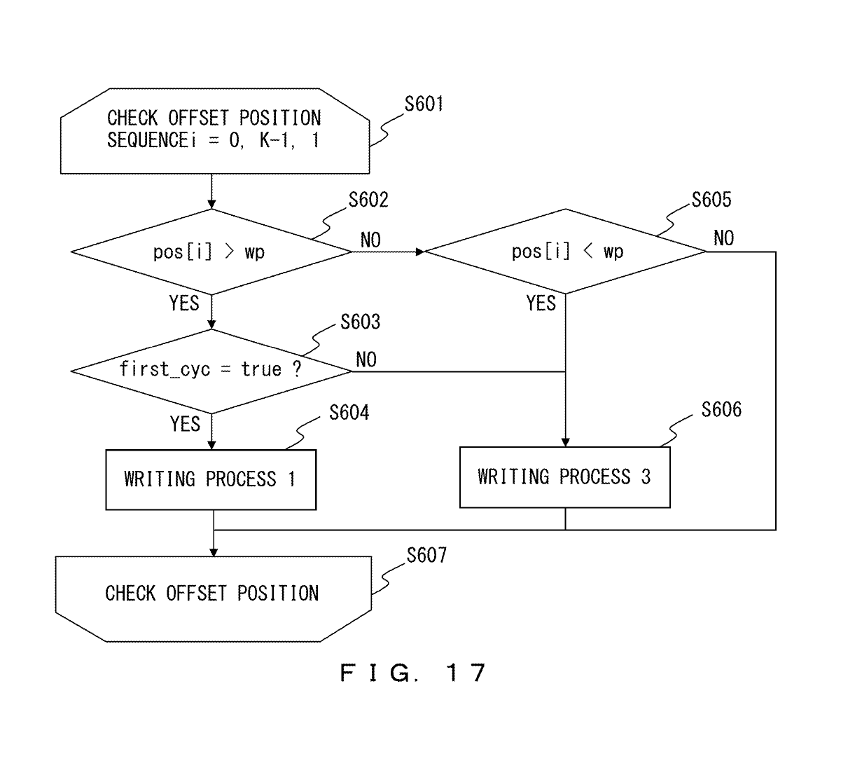

FIG. 17 illustrates an operation flow diagram for a situation in which the controlling unit 43 detects termination data in stream data.

The processes of S601-S607 are repeatedly performed for all sequences. That is, the processes (loop) of S601-S607 are repeatedly performed for the range of 0 to K−1 of the variable i, which indicates a sequence and is incremented at the end of each loop (S607).

First, the controlling unit 43 determines whether the index value of an offset position for the sequence i within the circular buffer is higher than the index value of the storage position at which the termination data is stored. In particular, the controlling unit 43 determines whether the value pos [i] is higher than the value wp (S602). Let the value wp be the value of the index at which the termination data is stored plus 1. When pos [i] is higher than wp (Yes in S602), the controlling unit 43 determines which of true or false the value first_cyc is (S603).

When the first_cyc is true in S603 (Yes in S603), the controlling unit 43 performs the writing process 1 (S604), which was described above with reference to FIG. 14 (S401-S406). After the writing process 1 is performed, the process transfers to S607.

When the first_cyc is false in S603 (No in S603), the controlling unit 43 performs the writing process 3 (S606). After the writing process 3 is performed, the process transfers to S607.

When, in S602, the index value of an offset position for the sequence i is equal to or lower than the index value of the storage position at which the termination data is stored, the controlling unit 43 determines whether the index value of the offset position for the sequence i is lower than the index value of the storage position at which the termination data is stored. In other words, when the value pos [i] is equal to or lower than the value wp in S602 (No in S602), the controlling unit 43 determines whether pos[i] is lower than wp (S605).

Determining in S605 that the index value of the offset position for the sequence i is lower than the index value of the storage position at which the termination data is stored, the controlling unit 43 performs the writing process 3. That is, on determining in S605 that pos[i] is lower than wp (Yes in S605), the controlling unit 43 performs the writing process 3 (S606). After the writing process 3 is completed, the process transfers to S607.

When it is determined in S605 that the index value of the offset position for the sequence i is equal to or higher than the index value of the storage position at which the termination data is stored, i.e., that pos[i] is equal to or higher than wp (No in S605), the process transfers to S607.

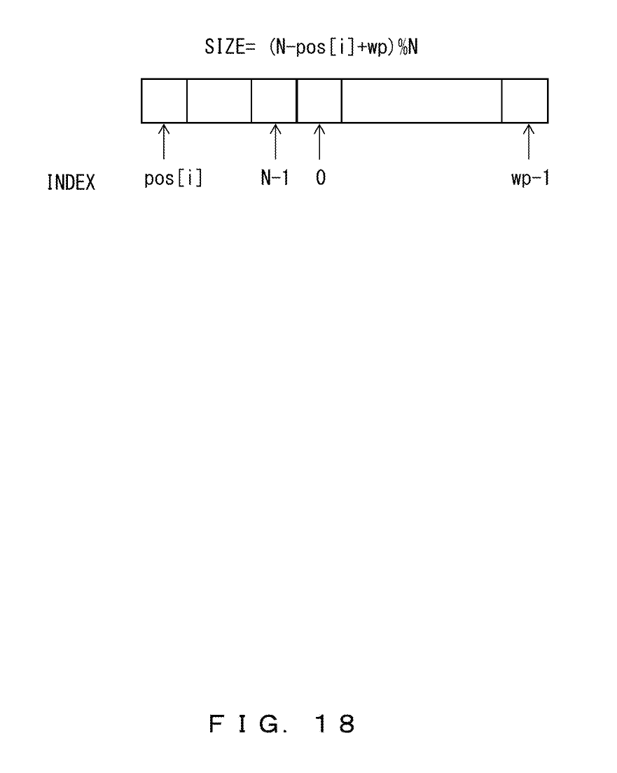

FIG. 18 illustrates the writing process 3. In the writing process 3, the controlling unit 43 performs a block generating process wherein the pieces of data designated by indices pos[i] to N−1 in the circular buffer are collected in ascending order of index, and wherein, when the index is reached to N, the pieces of data ranging from indices 0 to wp−1 are collected in an ascending order. Note that the block size is (N−pos[i]+wp) % N.

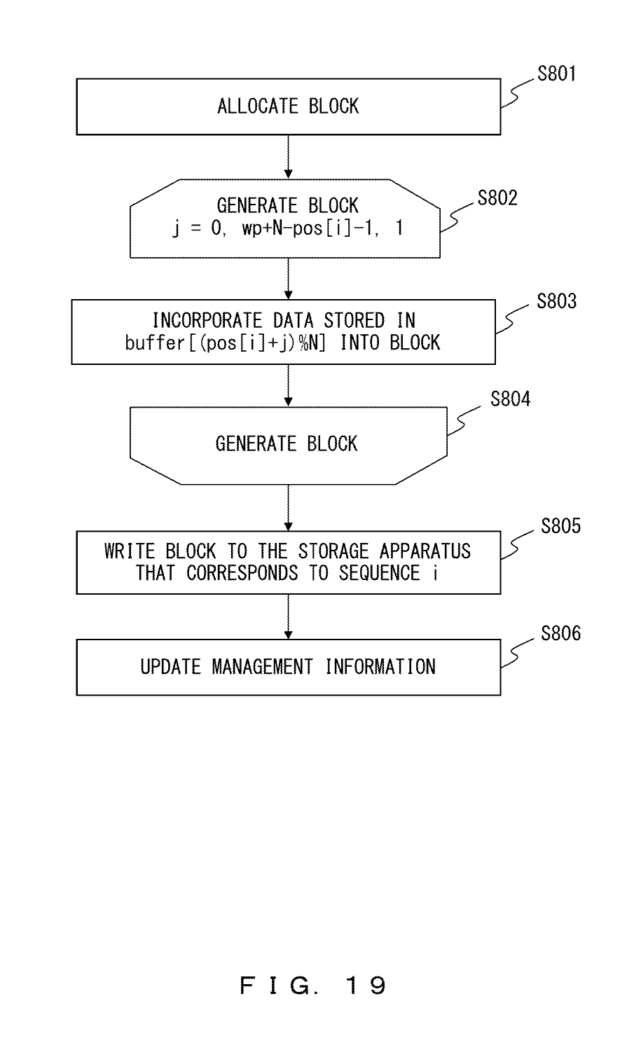

FIG. 19 illustrates the operation flow diagram of the writing process 3. In a loop process of S802-S804, the controlling unit 43 performs a process of collecting pieces of data within the circular buffer into one block.

First, the controlling unit 43 allocates an object block for writing and also assigns a block number to the object block (S801). In S801, the object block for writing does not include stream data.

The process loop of S802-S804 indicates a process of incorporating pieces of stream data within the circular buffer into the block that has the block number assigned in S801.

First, the controlling unit 43 assigns 0 to a variable j that designates an index of the buffer for which the writing process is performed (S802). The controlling unit 43 incorporates data stored in buffer[(pos[i]+j) % N] into the block that has the block number assigned in S801 (S803). The controlling unit 43 increments the value j and determines whether j satisfies 0≦j≦wp+N−pos[i]−1 (S802). When 0≦j≦wp+N−pos[i]−1 is satisfied, the process loops to perform S803 again. When j<0 or j≧wp+N−pos [i] in S802, the loop ends, then the process transfers to S805.

In S805, the controlling unit 43 writes the object block for writing generated in S801-S804 to the storage apparatus 47 that corresponds to the sequence i.

The controlling unit 43 stores information on the written block in the management information 60 of the block-section DB 45 (S806). That is, the controlling unit 43 generates a new record in the management information 60 and respectively stores the block number, the start time, the finish time, and the sequence i of the block written in S805 in the block number 61, the start time 62, the finish time 63, and the sequence number 64 of the created record.

The following will describe an operation for changing a redundancy degree.

A redundancy degree is changed at a timing ranging from the end of a writing process performed by the controlling unit 43 to the reception of the next stream data. That is, the change is made during the period from the end of the loop process of S305-S310 in FIG. 12 to another start of the process of S301, or the period from the end of the loop process of S601-S607 in FIG. 17 to another start of the process of S301 in FIG. 12. A change in redundancy degree affects stream data received after the changing process is performed.

The changing of a redundancy degree includes a process of increasing the redundancy degree and a process of decreasing the redundancy degree.

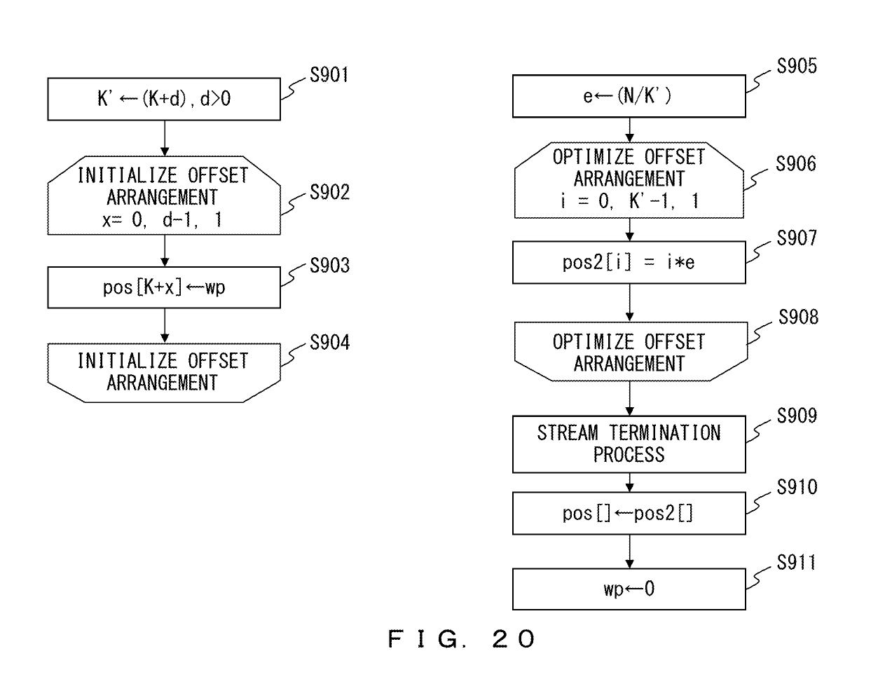

First, descriptions will be given of the process of increasing a redundancy degree. FIG. 20 illustrates the operation flow diagram of a process of increasing a redundancy degree.

In FIG. 20, an updated redundancy degree K′ indicates redundancy degree K plus d (d is an integer that is higher than 0). First, the controlling unit 43 initializes the updated redundancy degree K′. That is, the controlling unit 43 assigns a value of K+d to K′ (S901). Then, the controlling unit 43 initializes elements from K to K′−1 of an offset array. That is, the controlling unit 43 assigns wp to the values from pos [K] to pos [K′−1] (S902-S904).

Next, a working array pos2[ ] is defined that is used to rearrange offset positions for the sequences after redundancy-degree change with equal intervals in the circular buffer. Prior to the defining of the working array pos2[ ], a variable e, which is used to define pos2[ ], is defined, and N/K′ is assigned to e (S905).

pos2[ ] is an array that includes K′ elements, each of which stores information at an offset position for a sequence that corresponds to the subscript. The offset positions are arranged with equal intervals in the circular buffer. That is, while variable i, which indicates a sequence, satisfies 0≦i≦K′−1, the process of pos2[i]=i*e is repeatedly performed. The value i is incremented at the end of each loop (S906-S908).

Next, a process is performed of writing, to a storage apparatus 47, data put in the circular buffer before the redundancy degree is changed (S909). In particular, a process is performed that is identical with the process performed when the controlling unit 43 detects a stream termination. That is, the processes of S601-S607 in FIG. 17 are performed.

Subsequently, the controlling unit 43 copies the working array pos2[ ] defined in S906-S908 to the offset array pos[ ] (S910). That is, the controlling unit 43 assigns the value of each element of pos2[ ] to each element of pos[ ] where both subscripts correspond with each other, e.g., assigns the value of pos2[0005] to pos[0004], the value of pos2[0007] to pos[0006], and so on. In the absence of an element of pos[ ] that corresponds to pos2[ ], the value of pos2[ ] is assigned to a newly created element of pos[ ]. As an example, the value of pos2[K′−1] is assigned to pos[K′−1]. Thus, after the assigning, pos[ ] includes K′ elements.

The controlling unit 43 assigns 0 to a variable wp, which indicates a storage position within the circular buffer (S911). This means that, after the redundancy-degree changing process for the circular buffer is performed, pieces of received stream data are stored at positions which start from the position with index 0 within the circular buffer.

The order of performing S901-S908 and the order of performing S909 may be reversed. S911 may be performed before or after any of S901-S910 is performed.

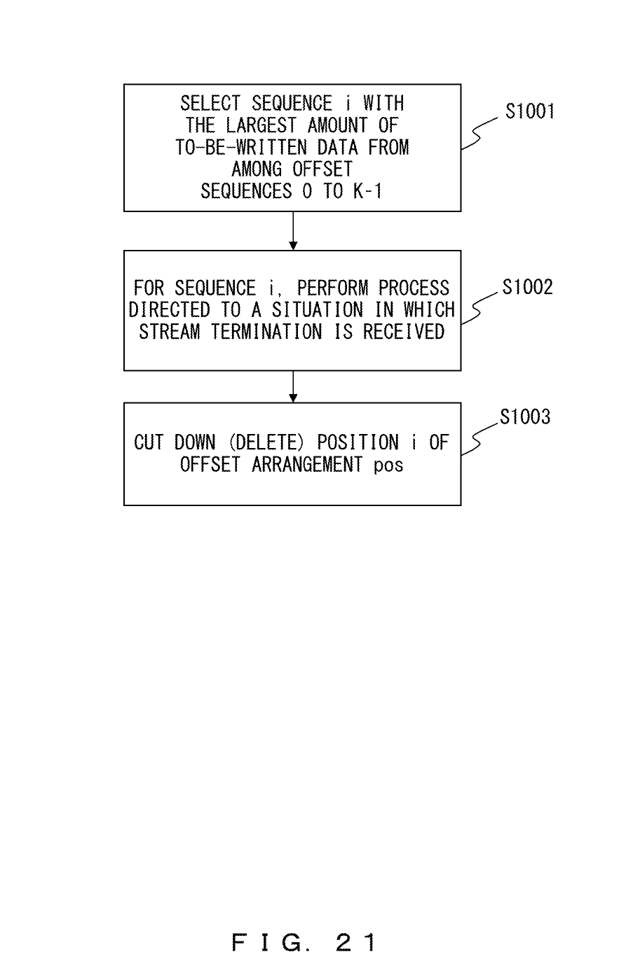

The following will describe the process of decreasing a redundancy degree. FIG. 21 illustrates the operation flow diagram of the process of decreasing a redundancy degree.

FIG. 21 depicts the operation flow diagram under a condition in which redundancy degree K has decreased by 1. When redundancy degree K decreases by d, the operation flow diagram of FIG. 21 is performed d times.

First, the controlling unit 43 selects, from the sequences (0 to K−1), a sequence i for which the largest number of pieces of to-be-written data are stored in the circular buffer (S1001). To-be-written data refers to data for which the writing process directed to a storage apparatus 47 has never been performed from among the data stored in the circular buffer. A sequence with the largest number of pieces of to-be-written data refers to a sequence with the largest number of indices assigned to regions in which pieces of to-be-written data are stored.

Next, for the sequence i, the controlling unit 43 performs the process directed to a situation in which a stream termination is received (S1002). That is, the processes of S601-S607 in FIG. 17 are performed.

The controlling unit 43 cuts down (deletes) a position i of the offset array pos[ ] (S1003). As an example, a process of deleting the value of pos[K−1] is performed by assigning the value of pos[i+1] to pos[i], the value of pos[i+2] to pos[i+1], . . . , and the value of pos[K−1] to pos[K−2].

Through S1001-S1003, the updated redundancy degree K′ becomes K−1. In addition, performing S1001-S1003 d times may decrease the redundancy degree by d.

After S1003, the processes indicated by S905-S911 in FIG. 20 may be performed to arrange the offset arrays with equal intervals within the circular buffer.

An excessive redundancy may be prevented from being achieved by performing the process of changing a redundancy degree depicted in FIG. 20 or 21 in accordance with a data importance for each time interval of a stream, but data importance is often settled after the actual-time input of stream data Accordingly, for a block that has already been stored in a storage apparatus 47 once, the controlling unit 43 performs a redundancy reestablishment process to achieve a redundancy degree that depends on an importance. In the redundancy reestablishment process, a block stored in a storage apparatus 47 is read, and the block size and the redundancy degree are changed to optimize a random-access feature and memory utilization in the reproduction process.

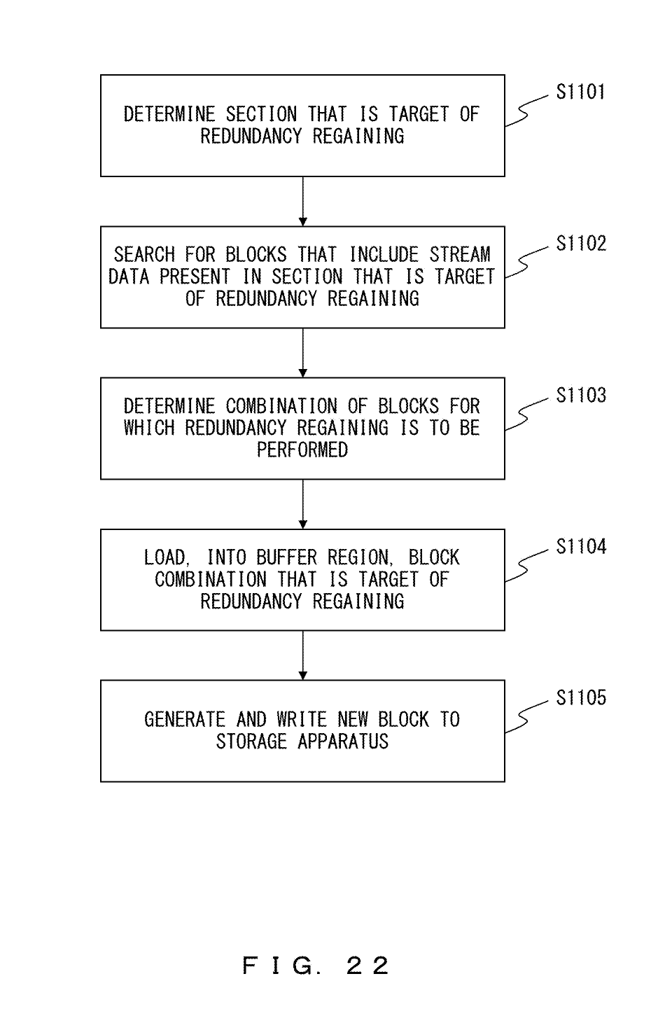

The following will describe operations of the redundancy reestablishment process in detail. FIG. 22 illustrates the operation flow diagram of the redundancy reestablishment process.

First, the controlling unit 43 determines a section that is a target of redundancy reestablishment (S1101). The section refers to a predetermined continuous range in the time series of stream data. A section that is a target of redundancy reestablishment is determined according to, for example, the importance of stream data. As an example, the controlling unit 43 obtains an importance of stream data for each time point and, according to a range where the importance is constant, determines a section that is a target of redundancy reestablishment. In particular, when importance is expressed by three stages which is A, B, and C, the controlling unit 43 may designate a continuous range with importance A (fixed) as a section that is a target of redundancy reestablishment. As another example, a section that would not become a start time point for random-access reproduction may be designated as a section that is a target of redundancy reestablishment.

When a section that is a target of redundancy reestablishment is determined and a start time and a finish time thereof are determined, the controlling unit 43 searches the block-section DB 45 for a plurality of blocks that include data present in that section (S1102).

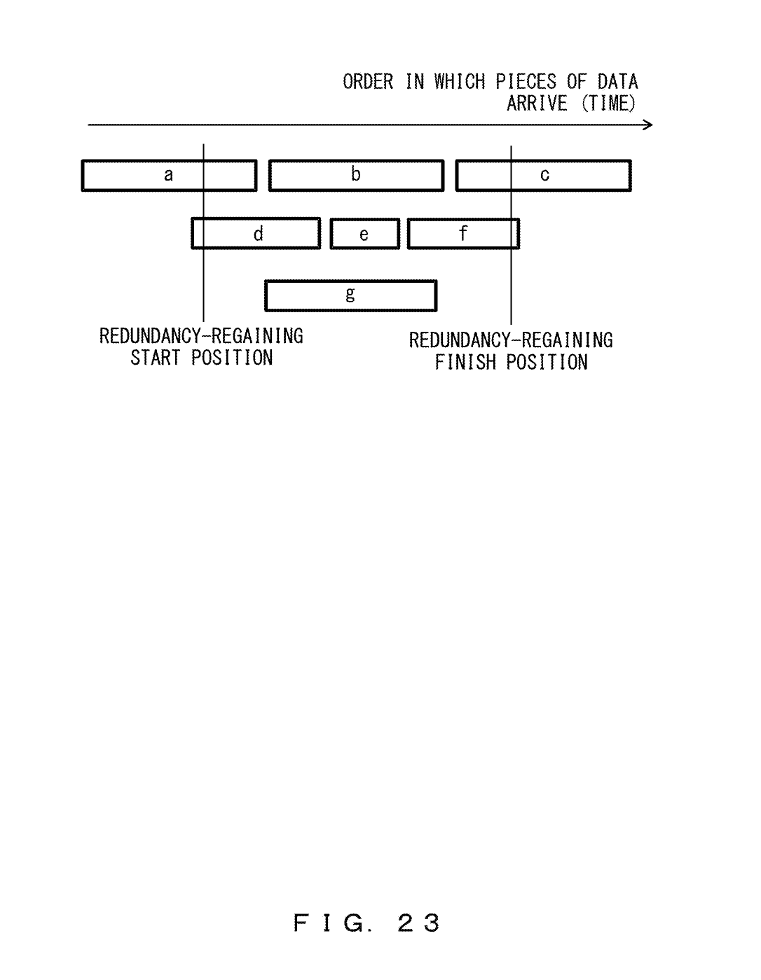

FIG. 23 illustrates examples of a plurality of blocks that include data present in a section that is a target of redundancy reestablishment. In FIG. 23, {a, b, c, d, e, f, g} are blocks that include data present in a range from a redundancy-reestablishment start position to a redundancy-reestablishment finish position.

The controlling unit 43 determines a combination of blocks for which redundancy reestablishment is to be performed (S1103). In particular, the controlling unit 43 derives a block combination using an optimum solution or an approximate solution according to evaluation functions of random-access-based read performance and a memory utilization. In FIG. 23, in the reading of the data present in the range from the start position to the finish position, block combinations such as {d, e, f} and {d, f, g} are derived in addition to {a, b, c}. The controlling unit 43 derives an optimum combination from those combinations using various techniques for optimizing the combinations. As an example, a combination may be derived that satisfies a time width and that has the smallest possible number of overlaps in the data present in the redundancy-reestablishment target section.

The controlling unit 43 loads the block combination determined in S1103 into the circular buffer (S1104). Note that blocks may be loaded into a predetermined storage region rather than the circular buffer.

The controlling unit 43 deletes an overlap of the plurality of blocks loaded in S1104, or generates a new block by joining the plurality of blocks and stores the generated block in the storage apparatus 47 (S1105).

A block already stored in a storage apparatus 47 may be read to generate a stream extending from the redundancy-reestablishment start position to the finish position, and the redundancy-degree changing process described with reference to FIGS. 20 and 21 may be applied to the generated stream. This allows the data extending from the redundancy-reestablishment start position to the finish of the start to have a redundancy degree determined after stream data is stored in the storage apparatus 47.

The redundancy reestablishment process may be performed as follows. First, the information processing apparatus reads a block already stored in a storage apparatus and generates a stream extending from a redundancy-reestablishment start position to a finish of the start. Using a block size N that is different from the size used in the previous storing process, the information processing apparatus performs, for the generated stream, a process for writing a block that is similar to the one described with reference to FIGS. 12-19. This allows the data extending from the redundancy-reestablishment start position to the finish of the start to have a block size determined after stream data is stored in the storage apparatus 47.

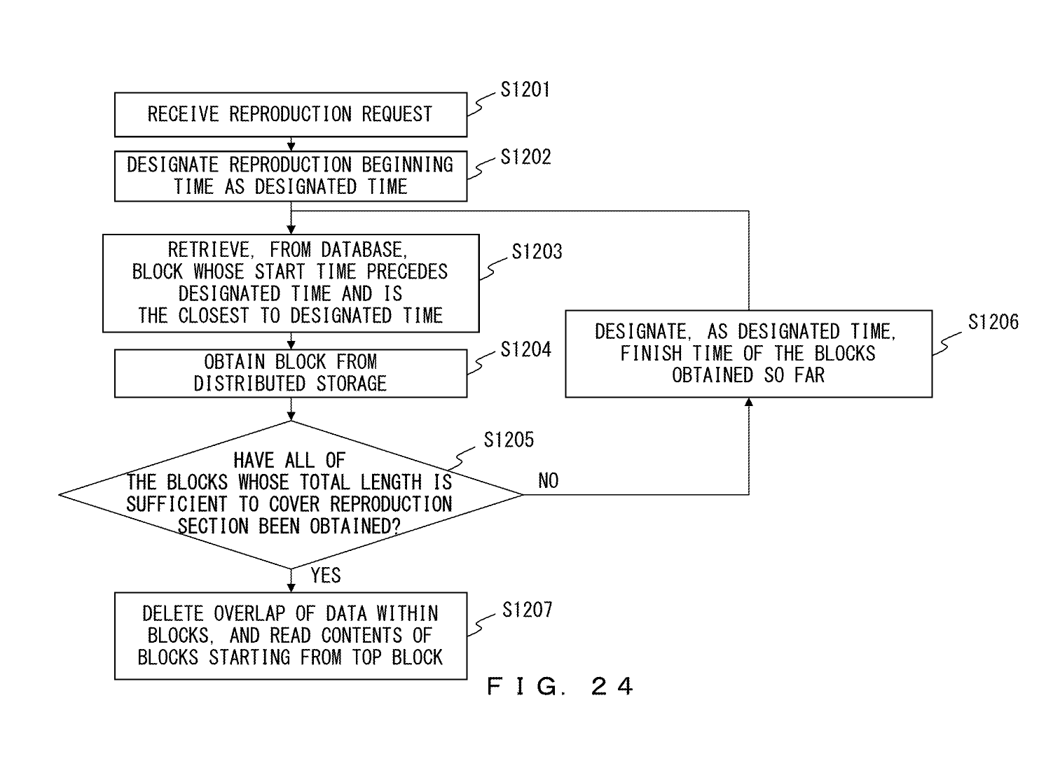

FIG. 24 illustrates an operation flow diagram for data reproducing.

First, the request receiving unit 51 receives a reproduction request (S1201). The reproduction request includes a reproduction start time and a reproduction finish time of an object for which the reproduction request has been made.

The controlling unit 52 designates the reproduction start time included in the received reproduction request as a designated time, which is a working variable used to obtain a block that includes the stream data for which the reproduction request has been made (S1202).

The controlling unit 52 retrieves from the block section DB 54 a block whose start time precedes the designated time and is the closest to the designated time from among the plurality of blocks stored in a storage apparatus 59 (S1203). In particular, the controlling unit 52 refers to the start times 62 of the management information 60 stored in the block section DB 54 and retrieves a record whose start time precedes the designated time and is the closest to the designated time.

The controlling unit 52 transmits a block reading request to a storage apparatus 59 via the request transmitting unit 55 and obtains a block (S1204). In particular, the controlling unit 52 transmits a block obtainment request for block number 61 to the storage apparatus 59 that corresponds to a sequence having the sequence number 64 of the record retrieved in S1203. The storage apparatus 59 that has received the block obtainment request transmits the block designated by the block number to the information processing apparatus 50. The information processing apparatus 50 receives, from the storage apparatus 59 and via the block receiving unit 56, the block for which the obtainment request has been made.

The controlling unit 52 determines whether all of the blocks whose total length is sufficient to cover a reproduction section have been obtained (S1205). In particular, when any of the blocks obtained in S1204 has a finish time that follows the reproduction finish time included in the reproduction request, the controlling unit 52 determines that all of the blocks whose total length is sufficient to cover the reproduction section have been obtained.

When it is determined in S1205 that all of the blocks whose total length is sufficient to cover the reproduction section have not been obtained (No in S1205), the controlling unit 52 designates, as a new designated time, the latest finish time from among the finish times of the plurality of blocks obtained in S1204 (S1206). Then, the process transfers to S1203.

When it is determined in S1205 that all of the blocks whose total length is sufficient to cover the reproduction section have been obtained (Yes in S1205), the controlling unit 52 deletes, from the plurality of blocks obtained in S1204, an overlap of pieces of stream data associated with a certain time point and generates a reproduction stream. The controlling unit 52 transmits the reproduction stream to a terminal that is the source of the request for the reproduction process (S1207). Then, the process ends.

### Embodiment 2

In embodiment 1, in the redundancy-degree changing process, all of the contents in the circular buffer are flushed out as blocks before an offset position is changed (S909), and the following process starts with the storage position wp indicated as 0 within the circular buffer. Hence, the size of a block written just before or after the redundancy-degree changing process becomes small in comparison with what would be achieved in the case where the redundancy-degree changing process is not performed.

Accordingly, in embodiment 2, in the redundancy-degree changing process, in consideration of the current storage position wp, the amount of to-be-written data for each sequence i, a pre-update offset, and a post-update offset, an offset position is updated in a manner such that not all of the contents in the circular buffer are written. This decreases the number of times the writing process is performed in the changing of a redundancy degree, and decreases the frequency with which a small-size block is stored.

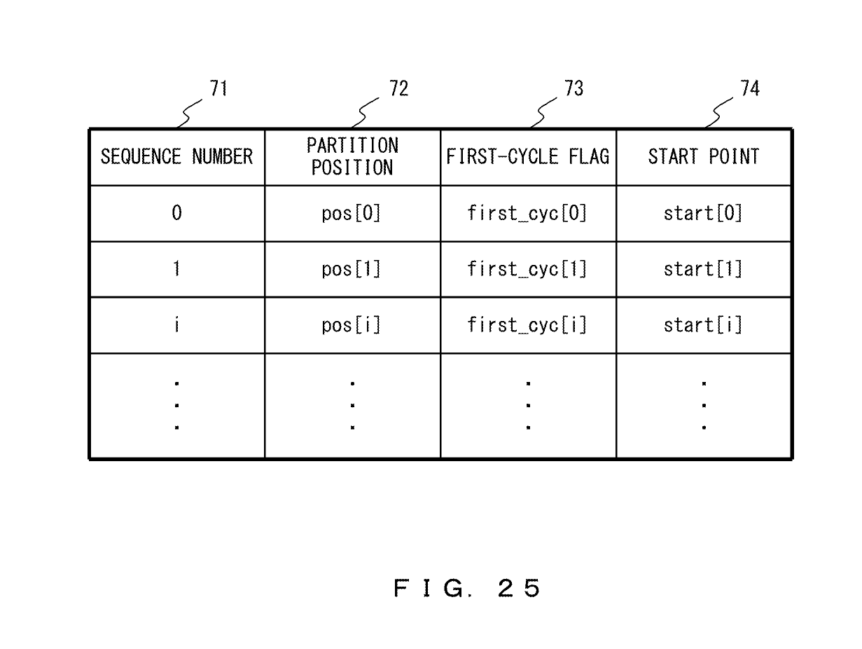

In embodiment 2, a start point in the circular buffer and the value first_cyc are managed for each sequence. FIG. 25 depicts an example of information indicating relationships between sequence numbers 71, partition positions 72, first-cycle flags 73, and start points 74, all of which are control variables for a writing process in accordance with embodiment 2.

A sequence number 71 is information for unique identification of a sequence. A partition position 72 is information on an offset position for a sequence that corresponds to a sequence number 71. A first-round flag is information on a first-round flag for a sequence that corresponds to a sequence number 71. The first-round flag is similar to the first-round flag described with reference to embodiment 1. In embodiment 2, however, as a start position is different for each sequence, the value of a first-round flag is different for each sequence. A start point 74 is information indicating the start position of a sequence that corresponds to a sequence number 71 within the circular buffer. The start point 74 is indicated as the value of the arrangement start[ ], and the start position of the sequence i expressed as start[i]. In embodiment 1, start positions are index 0 for all sequences, i.e., start[i] is always 0 irrespective of block i. In embodiment 2, the value of start[i] may be different for each sequence.

The configurations of the information processing apparatus related to a writing process and a reading process in accordance with embodiment 2 are similar to the configurations in accordance with embodiment 1 described with reference to FIGS. 7 and 8.

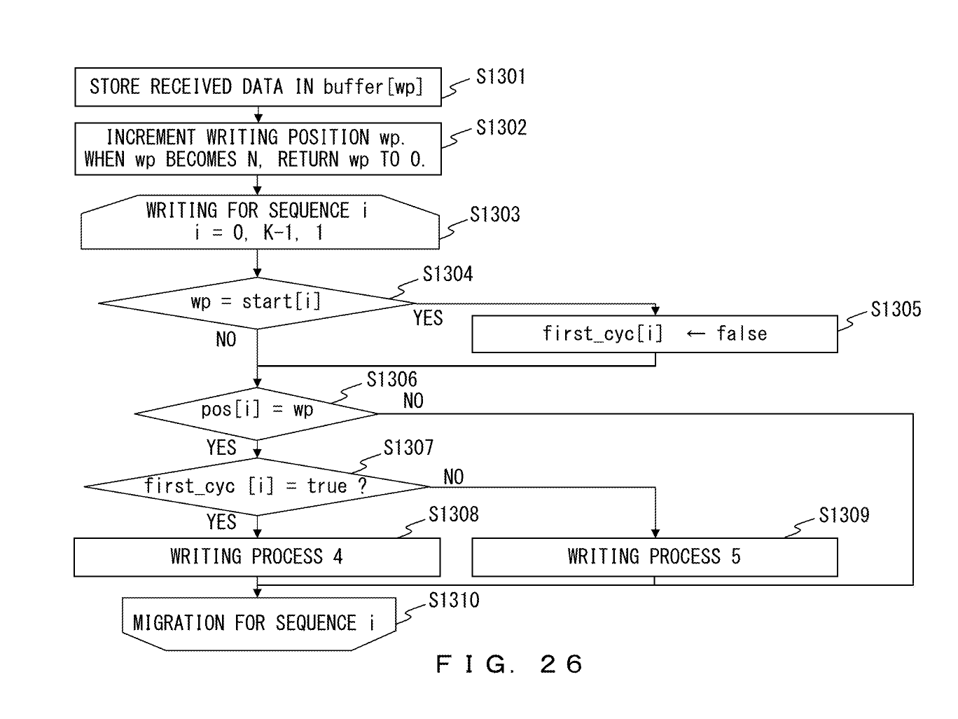

FIG. 26 illustrates an operation flow diagram for block generation and a writing process for writing to a storage apparatus in accordance with embodiment 2.

In FIG. 26, N indicates the buffer size of the circular buffer; buffer[ ], the circular buffer; K, a redundancy degree; pos[ ], an array wherein the value of an offset position for each sequence plus 1 is stored. In addition, wp indicates a variable indicating the index of a storage position within the circular buffer at which data is stored by the stream-data receiving unit 41. A first-round flag array first_cyc [K] indicates an array in which a variable is stored that indicates whether information has been stored in all of the indices of the circular buffer at least once.

The circular buffer buffer[ ], the offset array pos[ ], and the storage position wp are the same as those described with reference to embodiment 1 and thus the descriptions thereof are omitted herein.

The first-round flag array first_cyc[ ] is an array in which first-cycle flags each directed to a sequence are stored as elements.

In a variable initialization process, the controlling unit 43 assigns 0 to the storage position wp and “true” to all of the elements of the first-cycle flag array first_cyc[ ]. The controlling unit 43 also stores, in each element of the offset array pos[ ], the value of an offset position for each sequence plus 1.

After the variable initialization process, the controlling unit 43 performs the processes of S1301-S1310 every time stream data is received. One loop of S1301-S1310 is a process performed every time the stream-data receiving unit 41 receives one piece of stream data, and is also a process wherein stream data is stored at one index of the circular buffer. Every time the loop is completed, a storage position wp within the circular buffer is incremented one by one. When a processing loop is finished in which data is stored at the last index of the circular buffer, a loop follows in which data is stored at the initial index.

Upon receipt of stream data, the controlling unit stores the received data in buffer[wp] (S1301). As described above, wp is a variable indicating an index at which stream data is stored within the circular buffer. Next, the controlling unit 43 increments the value wp (S1302).

In S1302, when the value wp becomes N (buffer size) after the value of the storage position wp is incremented, the controlling unit 43 assigns 0 to wp. This process indicates an operation wherein pieces of stream data are stored at indices starting from the initial index of the circular buffer and, when a piece of data is stored at the last index, the next piece of data is stored at the initial index.

The controlling unit 43 repeatedly performs the writing process of S1303-S1310 for all sequences. That is, the processes (loop) of S1303-S1310 are repeatedly performed for the range of 0 to K−1 of the variable i, which indicates a sequence and is incremented at the end of each loop.

In the loop of the writing process, the controlling unit 43 determines whether wp is equal to start[i] (S1304). The fact that wp is equal to start [i] (Yes in S1304) means that data has been stored at all of the indices of the circular buffer at least once under a condition in which start[i] is the start position, thereby causing the controlling unit 43 to set the value first_cyc[i] to “false” (S1305). Then, the process transfers to S1306. When wp is not equal to start[i] in S1304 (No in S1304), the process transfers to S1306.

The controlling unit 43 determines whether pos[i] is equal to wp (S1306). In this example, as described above, pos[i] is the value of an offset position for the sequence i plus 1, and wp is a value obtained as a result of incrementing in S1302 the value indicating a storage position within the circular buffer at which received data is stored in S1301. That is, in S1306, it is determined whether the storage position within the circular buffer at which data is stored in S1301 is an offset position for the sequence i.

When it is determined in S1306 that pos[i] is different from wp (No in S1306), the process transfers to S1310. When it is determined in S1306 that pos[i] is equal to wp (Yes in S1306), the controlling unit 43 determines which of “true” or “false” the value first_cyc[i] is (S1307). When first_cyc[i] is “true” (Yes in S1307), the process transfers to a writing process 4 (S1308). When first_cyc[i] is “false” in S1307 (No in S1307), the process transfers to a writing process 5 (S1309).

The following will describe the writing process 4. The writing process 4 is performed during the period from the moment when a piece of stream data is stored at start[i] for the first time to the moment when a piece of data is stored at the last index of the circular buffer for the first time.

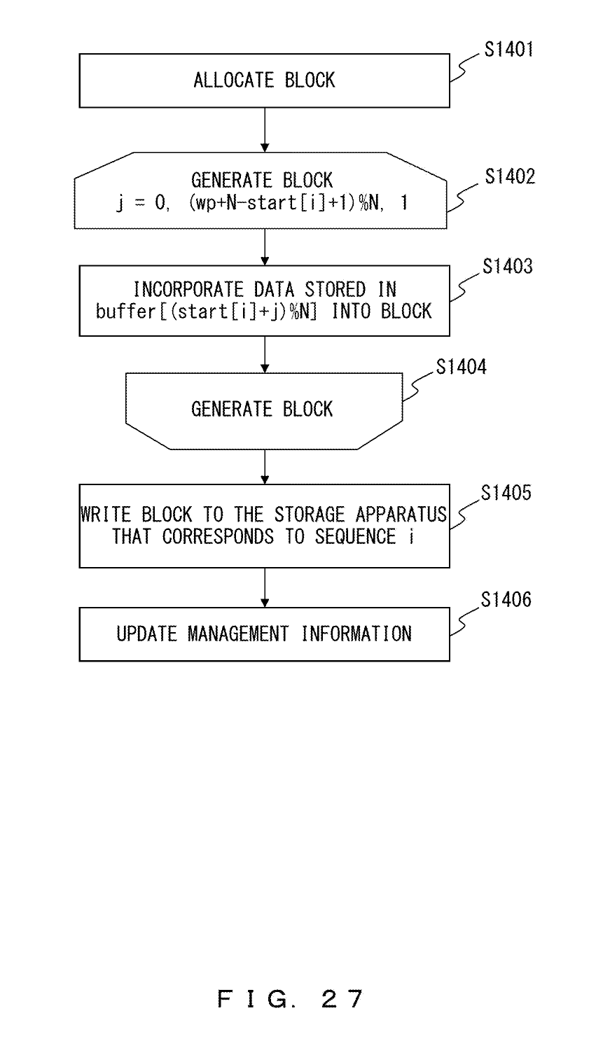

FIG. 27 illustrates the operation flow diagram of the writing process 4. In a loop process of S1402-S1404, the controlling unit 43 performs a process of collecting pieces of data designated by index start[i] to index (wp+N−start[i]+1) % N of the circular buffer into one block.

First, the controlling unit 43 allocates an object block for writing and also assigns a block number to the object block (S1401). In S1401, the object block for writing does not include stream data.

The process loop of S1402-S1404 indicates a process of incorporating pieces of stream data within the circular buffer into the block that has the block number assigned in S1401.

Pieces of stream data for earlier times within the circular buffer are earlier incorporated into the block. Hence, pieces of stream data for earlier times are located at more anterior portions of the block, i.e., the piece for the earliest time is located at the head of the block.

First, the controlling unit 43 assigns 0 to a variable j that designates an index of data to be incorporated into the object block for writing from among the stream data stored in the buffer (S1402). The controlling unit 43 incorporates data stored in buffer[(start[i]+j) % N] into the block that has the block number assigned in S1401 (S1403). The controlling unit 43 increments the value j and determines whether j satisfies 0≦j≦(wp+N−start[i]+1) % N (S1402). When 0≦j≦(wp+N−start[i]+1) % N, the process loops to perform S1403 again.

When j<0 or j≧(wp+N−start[i]+1) % N in S1402, the loop ends, then the process transfers to S1405.

In S1405, the controlling unit 43 performs a process of writing, via the block transmitting unit 46, the object block for writing generated in S1401-S1404 to the storage apparatus 47 that corresponds to the sequence i.

The controlling unit 43 stores information on the written block in the management information 60 of the block-section DB 45 (S1406). That is, the controlling unit 43 generates a new record in the management information 60 and respectively stores the block number, the start time, the finish time, and the sequence i of the block written in S1405 in the block number 61, the start time 62, the finish time 63, and the sequence number 64 of the created record.

The following will describe the writing process 5. The writing process 5 is an exemplary writing process performed when a data stream received by the stream-data receiving unit 41 is stored at an offset position in the circular buffer after data has been stored at all of the indices of the circular buffer at least once.

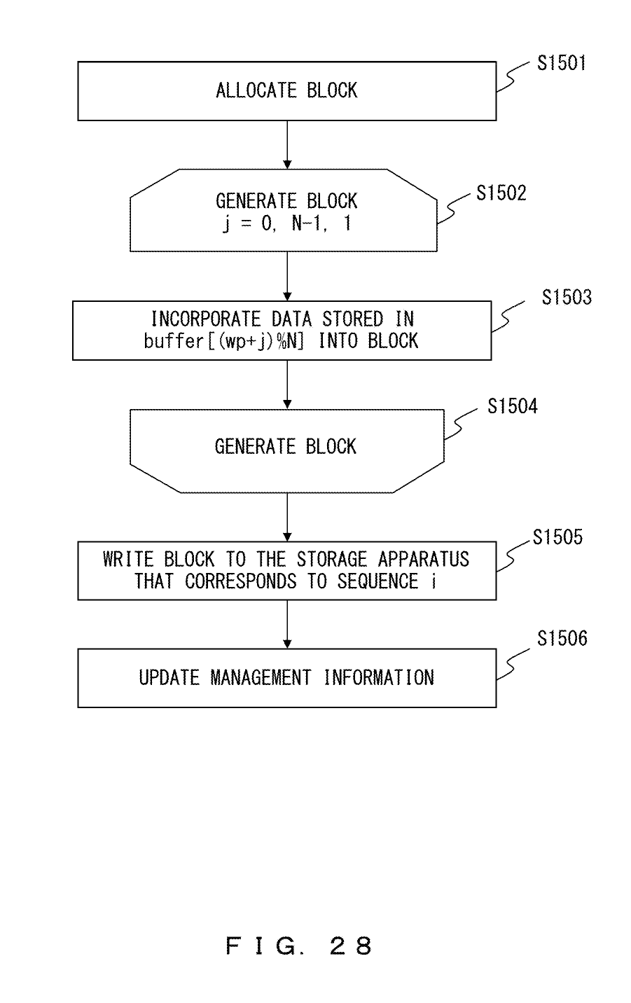

FIG. 28 illustrates the operation flow diagram of the writing process 5. In a loop process of S1502-S1504, the controlling unit 43 performs a process of collecting pieces of data within the circular buffer into one block.

First, the controlling unit 43 allocates an object block for writing and also assigns a block number to the object block (S1501). In S1501, the object block for writing does not include stream data.

The process loop of S1502-S1504 indicates a process of incorporating pieces of stream data within the circular buffer into the block that has the block number assigned in S1501.

In the loop, the controlling unit 43 assigns 0 to a variable j that designates an index of the buffer for which the writing process is performed (S1502). The controlling unit 43 incorporates data stored in buffer [(wp+j) % N] into the block that has the block number assigned in S1501 (S1503). The controlling unit 43 increments the value j and determines whether j satisfies 0≦j≦N−1 (S1502). When 0≦j≦N−1, the process loops to perform S1503 again. When j<0 or j≧N in S1502, the loop ends, then the process transfers to S1505.

In S1505, the controlling unit 43 performs a process of writing, via the block transmitting unit 46, the object block for writing generated in S1501-S1504 to the storage apparatus 47 that corresponds to the sequence i.

The controlling unit 43 stores information on the written block in the management information 60 of the block-section DB 45 (S1506). That is, the controlling unit 43 generates a new record in the management information 60 and respectively stores the block number, the start time, the finish time, and the sequence i of the block written in S1505 in the block number 61, the start time 62, the finish time 63, and the sequence number 64 of the created record.

The following will describe operations performed when the controlling unit 43 detects termination data in stream data. Detecting that stream data is termination data, the controlling unit 43 performs a process of storing, in any of the storage apparatuses 47, pieces of data that have not been stored in any storage apparatus 47 from among the pieces of data stored in the circular buffer at the moment when the termination data is put in the circular buffer.

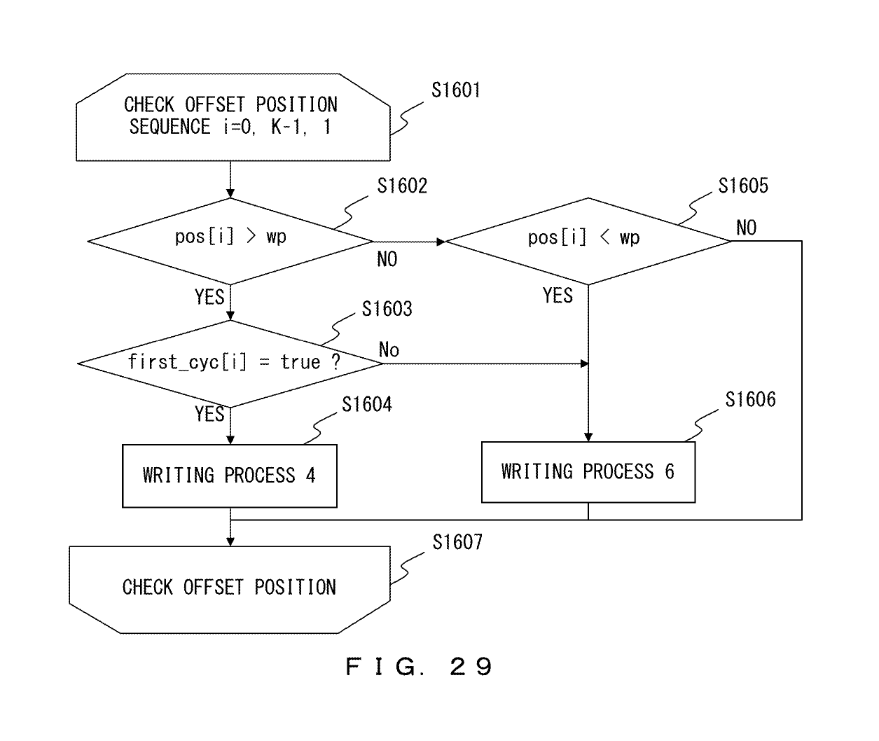

FIG. 29 illustrates an operation flow diagram for a situation in which the controlling unit 43 detects termination data in stream data.

Processes of S1601-S1607 are repeatedly performed for all sequences. That is, the processes (loop) of S1601-S1607 are repeatedly performed for the range of 0 to K−1 of the variable i, which indicates a sequence and is incremented at the end of each loop (S1607).

First, the controlling unit 43 determines whether the index value of an offset position for the sequence i within the circular buffer is higher than the index value of the storage position at which the termination data is stored. In particular, the controlling unit 43 determines whether the value pos[i] is higher than the value wp (S1602). Let the value wp be the value of the index at which the termination data is stored plus 1. When pos[i] is higher than wp (Yes in S1602), the controlling unit 43 determines which of “true” or “false” the value first_cyc[i] is (S1603).

When first_cyc[i] is “true” in S1603 (Yes in S1603), the controlling unit 43 performs the writing process 4 (S1604), which was described above with reference to FIG. 27 (S1401-S1406). After the writing process 4 is performed, the process transfers to S1607.

When first_cyc[i] is “false” in S1603 (No in S1603), the controlling unit 43 performs a writing process 6 (S1606). After the writing process 6 is performed, the process transfers to S1607.

When, in S1602, the index value of an offset position for the sequence i is equal to or lower than the index value of the storage position at which the termination data is stored, the controlling unit 43 determines whether the index value of an offset position for the sequence i is lower than the index value of the storage position at which the termination data is stored. In other words, when the value pos[i] is equal to or lower than the value wp in S1602 (No in S1602), the controlling unit 43 determines whether pos[i] is lower than wp (S1605).

Determining in S1605 that the index value of an offset position for the sequence i is lower than the index value of the storage position at which the termination data is stored, the controlling unit 43 performs the writing process 6. That is, determining in S1605 that pos[i] is lower than wp (Yes in S1605), the controlling unit 43 performs the writing process 6 (S1606). After the writing process 6 is completed, the process transfers to S1607.

When it is determined in S1605 that the index value of an offset position for the sequence i is equal to or higher than the index value of the storage position at which the termination data is stored, i.e., that pos[i] is equal to or higher than wp (No in S1605), the process transfers to S1607.

The following will describe operations of the writing process 6. The writing process 6 is performed when pieces of data are stored at all of the elements, and the controlling unit 43 determines that a piece of data stored in the circular buffer is termination data. In other words, the writing process 6 is performed when the controlling unit 43 determines that apiece of data stored in the circular buffer is termination data after a storage position wp within the circular buffer goes round the circular buffer for the first time

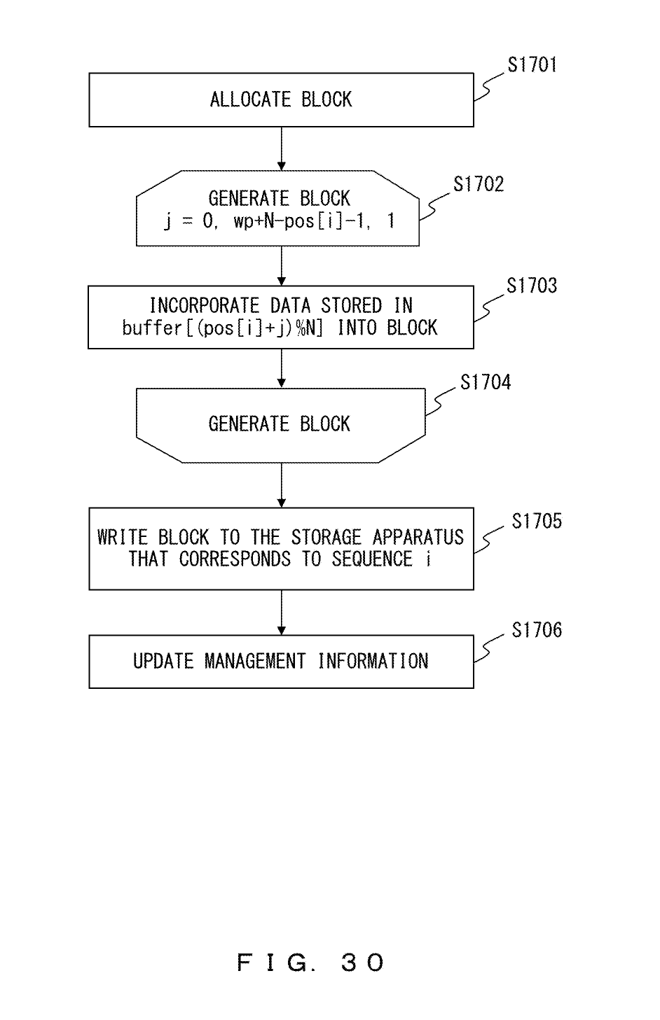

FIG. 30 illustrates the operation flow diagram of the writing process 6. In a loop process of S1702-S1704, the controlling unit 43 performs a process of collecting pieces of data within the circular buffer into one block.

First, the controlling unit 43 allocates an object block for writing and also assigns a block number to the object block (S1701). In S1701, the object block for writing does not include stream data.

The process loop of S1702-S1704 indicates a process of incorporating pieces of stream data within the circular buffer into the block that has the block number assigned in S1701.

First, the controlling unit 43 assigns 0 to a variable j that designates an index of the buffer for which the writing process is performed (S1702). The controlling unit 43 incorporates data stored in buffer [(pos[i]+j) % N] into the block that has the index assigned in S1701 (S1703). Then, the controlling unit 43 transfers the process to S1704. That is, the process returns to S1702. The controlling unit 43 increments the value j and determines whether j satisfies 0≦j≦wp+N−pos[i]−1 (S1702). When 0≦j≦wp+N−pos[i]−1, S1703 is performed again. When j<0 or j≧wp+N−pos[i]−1 in S1702, the loop ends, and the controlling unit 43 transfer the process to S1705.

In S1705, the controlling unit 43 performs a process of writing, via the block transmitting unit 46, the object block for writing generated in S1701-S1704 to the storage apparatus 47 that corresponds to the sequence i.

The controlling unit 43 stores information on the written block in the management information 60 of the block-section DB 45 (S1706). That is, the controlling unit 43 generates a new record in the management information 60 and respectively stores the block number, the start time, the finish time, and the sequence i of the block written in S1705 in the block number 61, the start time 62, the finish time 63, and the sequence number 64 of the created record.

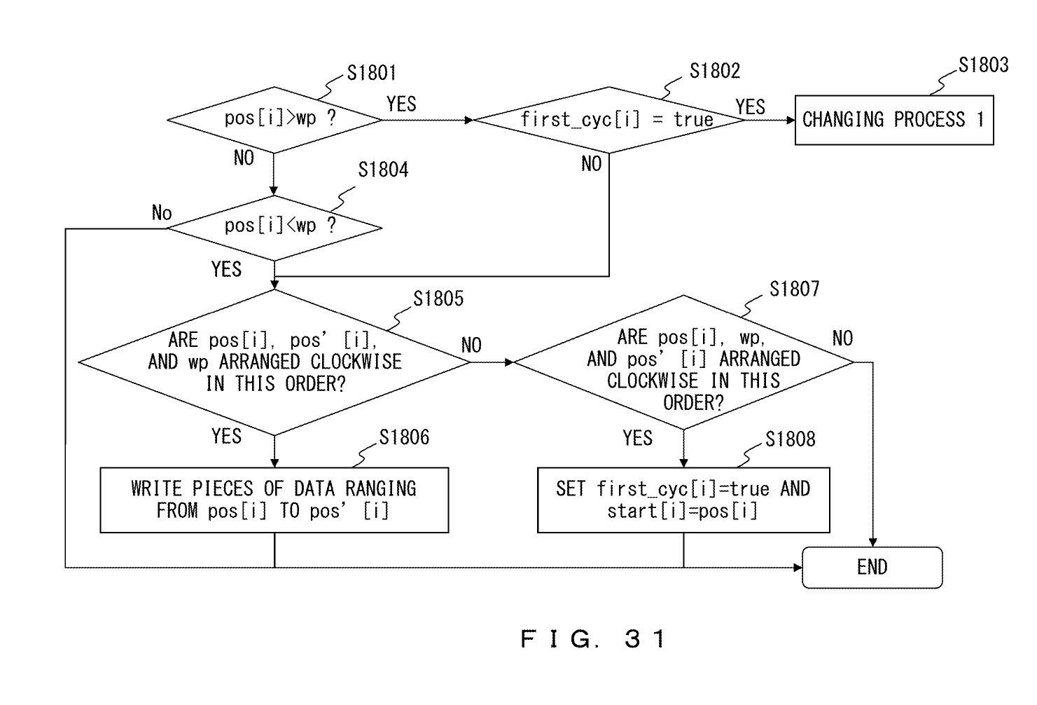

The following will describe an operation for changing a redundancy degree. The descriptions will be given of a situation in which the value of an offset array of the sequence i changes from pos[i] to pos′[i]. FIG. 31 illustrates an operation flow diagram for an offset-position changing in accordance with embodiment 2.

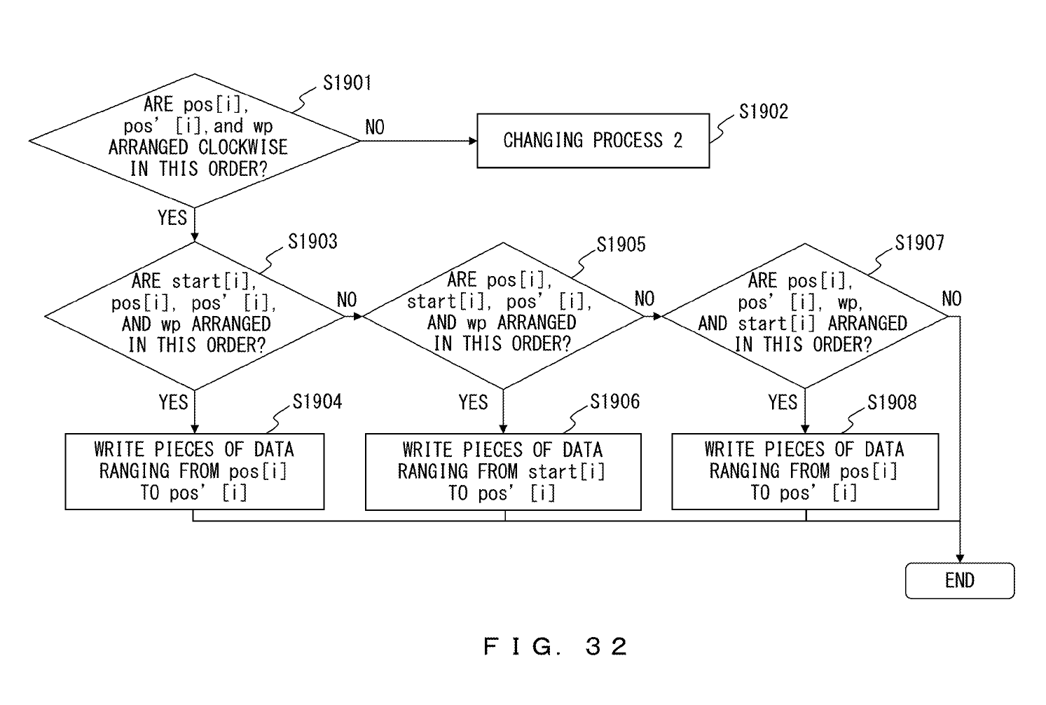

The controlling unit 43 determines whether pos[i] is higher than wp (S1801). Determining that pos [i] is higher than wp (Yes in S1801), the controlling unit 43 determines which of “true” or “false” the value first_cyc[i] is (S1802). When first_cyc[i] is “true” (Yes in S1802), the process transfers to a changing process 1 (S1803). The changing process 1 will be described hereinafter referring to FIG. 32.

When it is determined in S1802 that first_cyc[i] is “false” (No in S1802), the process transfers to S1805.

Determining in S1801 that pos [i] is equal to or lower than wp (No in S1801), the controlling unit 43 determines whether pos [i] is lower than wp (S1804). When it is determined that pos[i] is wp or higher (No in S1804), the process ends.

When it is determined in S1804 that pos[i] is lower than wp (Yes in S1804), the process transfers to S1805.

In S1805, the controlling unit 43 determines whether pos[i], pos′[i], and wp are arranged clockwise in this order within the circular buffer (S1805). “Clockwise” refers to a direction in which the index values of the circular buffer are arranged in sequence starting from the lowest index value, as indicated by the clockwise arrow in the circular buffer depicted in FIG. 10. Even when an index value of 0 is included, the order relationship remains. As an example, “pos[i], pos′[i], and wp are arranged clockwise in this order” includes a situation in which a region with index 0 is present between pos[i] and pos′[i]. Determining that pos[i], pos′[i], and wp are arranged clockwise in this order within the circular buffer (Yes in S1805), the controlling unit 43 performs the writing process of writing pieces of data ranging from pos[i] to pos'[i] (S1806). Then, the process ends.

Determining in S1805 that pos[i], pos′[i], and wp are not arranged clockwise in this order within the circular buffer (No in S1805), the controlling unit 43 determines whether pos [i], wp, and pos′[i] are arranged clockwise in this order within the circular buffer (S1807). Determining that pos[i], wp, and pos′[i] are arranged clockwise in this order within the circular buffer (Yes in S1807), the controlling unit 43 sets “true” to first_cyc[i] and sets the value of pos [i] to start[i] (S1808). Then, the process ends.

When it is determined in S1807 that pos[i], wp, and pos′[i] are not arranged clockwise in this order (No in S1807), the process ends.

The changing process 1 performed in S1803 will be described in the following. FIG. 32 illustrates the operation flow diagram of the changing process 1 in accordance with embodiment 2.

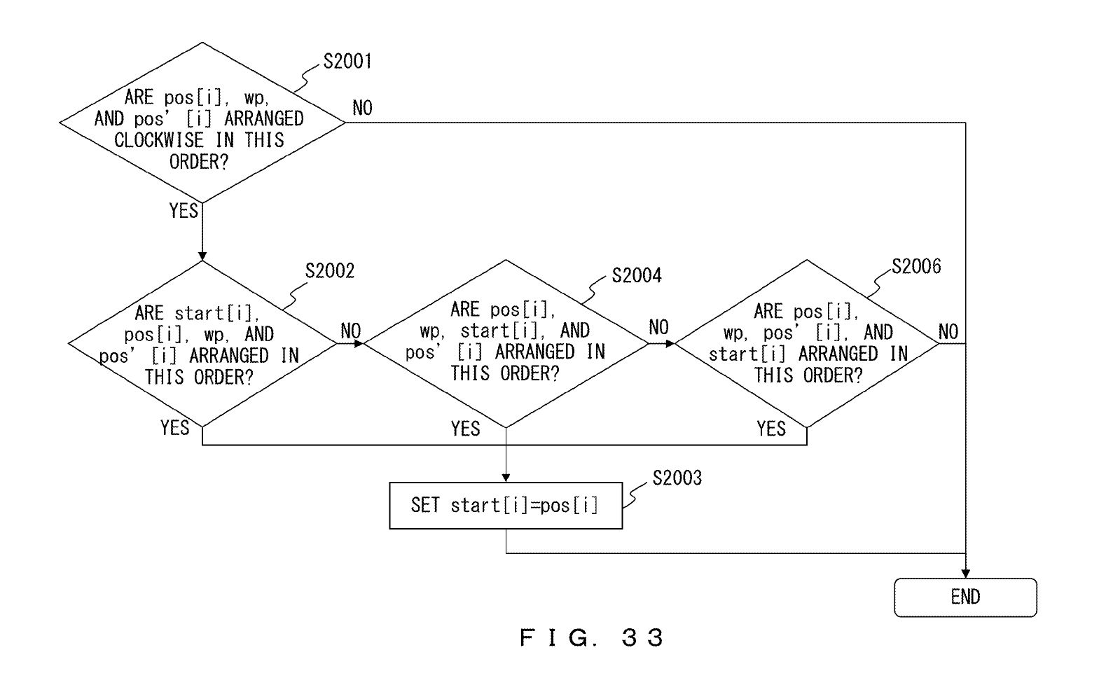

The controlling unit 43 determines whether pos[i], pos′[i], and wp are arranged clockwise in this order within the circular buffer (S1901). When the controlling unit 43 determines that pos[i], pos'[i], and wp are not arranged clockwise in this order within the circular buffer (No in S1901), the process transfers to the changing process 2 (S1902). The changing process 2 will be described hereinafter with reference to FIG. 33.

Determining in S1901 that pos[i], pos′[i], and wp are arranged clockwise in this order (Yes in S1901), the controlling unit 43 determines whether start[i], pos[i], pos′[i], and wp are arranged clockwise in this order within the circular buffer (S1903). Determining that start[i], pos[i], pos′[i], and wp are arranged clockwise in this order (Yes in S1903), the controlling unit 43 performs the writing process of writing pieces of data ranging from pos[i] to pos′[i] (S1904). Then, the process ends.

Determining in S1903 that start[i], pos[i], pos′[i], and wp are not arranged clockwise in this order (No in S1903), the controlling unit 43 determines whether pos[i], start[i], pos′[i], and wp are arranged clockwise in this order within the circular buffer (S1905). Determining that pos[i], start [i], pos′[i], and wp are arranged clockwise in this order (Yes in S1905), the controlling unit 43 performs the writing process of writing pieces of data ranging from start[i] to pos′[i] (S1906). Then, the process ends.

Determining in S1905 that pos[i], start[i], pos′[i], and wp are not arranged clockwise in this order (No in S1905), the controlling unit 43 determines whether pos[i], pos′[i], wp, and start[i] are arranged clockwise in this order within the circular buffer (S1907). Determining that pos[i], pos′[i], wp, and start [i] are arranged clockwise in this order (Yes in S1907), the controlling unit 43 performs the writing process of writing pieces of data ranging from pos[i] to pos′[i] (S1908). Then, the process ends.

When it is determined in S1907 that pos[i], pos′[i], wp, and start[i] are not arranged clockwise in this order (No in S1907), the process ends.

The changing process 2 performed in S1902 will be described in the following. FIG. 33 illustrates the operation flow diagram of the changing process 2 in accordance with embodiment 2.

The controlling unit 43 determines whether pos[i], wp, and pos′[i] are arranged clockwise in this order within the circular buffer (S2001). When the controlling unit 43 determines that pos[i], wp, and pos′[i] are not arranged clockwise in this order within the circular buffer (No in S2001), the process ends.

Determining in S2001 that pos[i], wp, and pos′[i] are arranged clockwise in this order (Yes in S2001), the controlling unit 43 determines whether start[i], pos[i], wp, and pos′[i] are arranged clockwise in this order within the circular buffer (S2002). Determining that start[i], pos[i], wp, and pos′[i] are arranged clockwise in this order within the circular buffer (Yes in S2002), the controlling unit 43 sets the value of pos[i] to start[i] (S2003). Then, the process ends.

Determining in S2002 that start[i], pos[i], wp, and pos′[i] are not arranged clockwise in this order (No in S2002), the controlling unit 43 determines whether pos[i], wp, start[i], and pos′[i] are arranged clockwise in this order within the circular buffer (S2004). Determining that pos [i], wp, start[i], and pos′[i] are arranged clockwise in this order (Yes in S2004), the controlling unit 43 sets the value of pos [i] to start[i] (S2003). Then, the process ends.

Determining in S2004 that pos [i], wp, start[i], and pos′[i] are not arranged clockwise in this order within the circular buffer (No in S2004), the controlling unit 43 determines whether pos[i], wp, pos′[i], and start[i] are arranged clockwise in this order within the circular buffer (2006). Determining that pos[i], wp, pos′[i], and start [i] are arranged clockwise in this order (Yes in S2006), the controlling unit 43 sets the value of pos[i] to start[i] (S2003). Then, the process ends.

When it is determined in S2006 that pos[i], wp, pos′[i], and start[i] are not arranged clockwise in this order (No in S2006), the process ends.

When a redundancy degree increases, a pre-change offset position that corresponds to an added sequence is not present, and the values of the start position and the first-round flag of the added sequence are in an initial state. That is, wp is set to start[i], and “true” is set to first_cyc[i], where i indicates an added sequence.

When a redundancy degree decreases, a post-change offset position for a deleted sequence is not present, and, for the deleted sequence, the writing process directed to the case of receiving a stream termination is performed. That is, the processes of S1601-S1607 in FIG. 29 are performed for pos[i], where i indicates a deleted sequence.

No processing is performed under a condition in which first_cyc[i] is “true” and pos [i], pos′[i], and wp are arranged clockwise in this order within the circular buffer and in which pos[i], pos′[i], start[i], and wp are arranged clockwise in this order. No processing is performed under a condition in which first_cyc[i] is “true” and pos[i], wp, and pos′[i] are arranged clockwise in this order within the circular buffer and in which pos[i], start[i], wp, and pos′[i] are arranged clockwise in this order.

As illustrated in FIGS. 31-33, changing an offset array includes a case where no processing is performed and a case where only a start point changes. In such cases, a writing process is not performed, leading to a high process efficiency in the changing of an offset array.

Operations in the data reproducing in embodiment 2 are the same as those in embodiment 1 described with reference to FIG. 24.

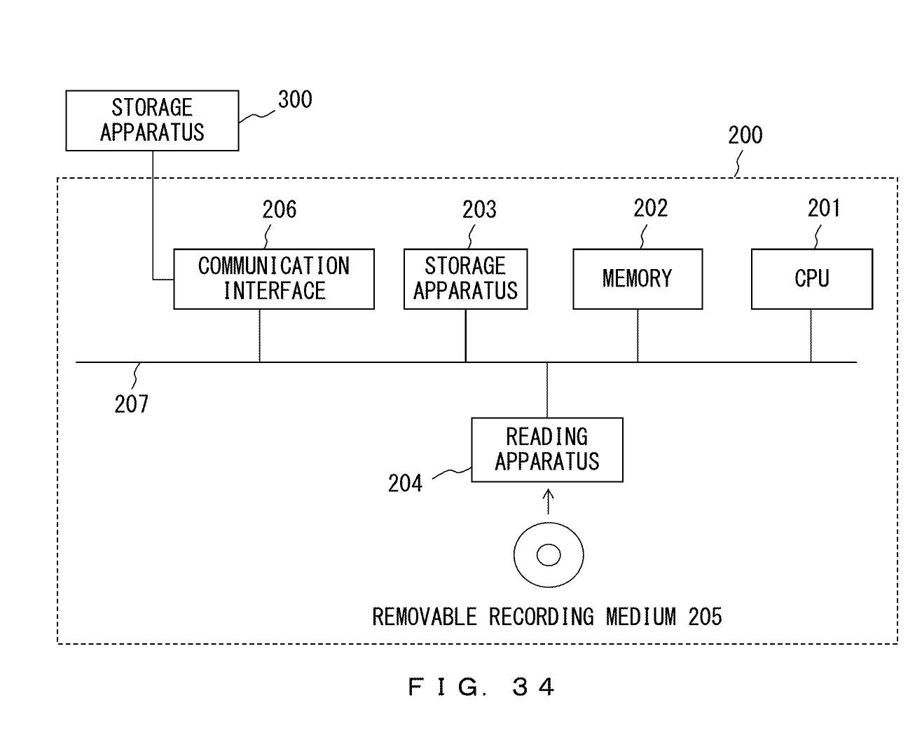

FIG. 34 illustrates an exemplary hardware configuration of an information processing apparatus 200 in accordance with the present embodiment. As depicted in FIG. 34, the information processing apparatus 200 includes a CPU (Central Processing Unit) 201, a memory 202, a storage apparatus 203, a reading apparatus 204, and a communication interface 206. The CPU 201, the memory 202, the storage apparatus 203, the reading apparatus 204, and the communication interface 206 are connected to each other via, for example, a bus 207. The information processing apparatus 200 is an example of the information processing apparatus 40 or 50.

Using the memory 202, the CPU 201 executes programs that describe the procedures in the flow diagrams described above. The CPU 201 provides some of or all of the functions of the controlling units 43 and 52.

The memory 202 is, for example, a semiconductor memory and is configured to include a RAM (Random Access Memory) region and a ROM (Read Only Memory) region. The memory 202 provides some of or all of the functions of the buffer regions 42 and 57 and the control-variable regions 44 and 53.

The storage apparatus 203 is, for example, a hard disk. The storage apparatus 203 may be a semiconductor memory such as a flash memory. The storage apparatus 203 may be an external recording apparatus. The storage apparatus 203 provides some of or all of the functions of the block-section DBs 45 and 54.

In accordance with an instruction from the CPU 201, the reading apparatus 204 accesses a removable recording medium 205. The removable recording medium 205 is achieved by, for example, a semiconductor device (e.g., USB memory), a medium to which information is input and from which information is output through a magnetic effect (e.g., magnetic disk), or a medium to which information is input and from which information is output through an optical effect (e.g., CD-ROM, DVD). The reading apparatus 204 is omissible.

In accordance with an instruction from the CPU 201, the communication interface 206 transmits or receives data via a network. The communication interface 206 provides some of or all of the functions of the stream-data receiving unit 41, the block transmitting unit 46, the request receiving unit 51, the request transmitting unit 55, the block receiving unit 56, and the reproduced-data transmitting unit 58. The communication interface 206 is connected to a storage apparatus 300 via a network or a bus. The storage apparatus 300 provides some of or all of the functions of the distributed storages 48 and 80. The information processing apparatus 200 may include the storage apparatus 300.

An information processing program for implementing the embodiment is provided to the information processing apparatus 200 in, for example, any of the following manners.

(1) Installed in the storage apparatus 203 in advance
(2) Provided by the removable recording medium 205
(3) Provided via a network

The information processing apparatuses 40 and 50 may have the same configuration.

The present embodiment is not limited to the aforementioned embodiments, and various configurations or embodiments may be used without departing from the spirit of the present embodiment.

The information processing system in accordance with the present embodiment may improve the read performance in random-access reproduction of a stream.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising:
a first storage unit configured to store first divided data indicating divided time-series data;
a second storage unit configured to store second divided data indicating divided time-series data divided at a time that is different from a time at which the first divided data is divided; and
an processor that executes a procedure including:
when a reproduction time is designated for the time-series data, reading and outputting divided data divided at a time just before the reproduction time from among the first divided data and the second divided data stored in the first storage unit and the second storage unit.

2. The information processing system according to claim 1, the procedure further including:
storing, in the first storage unit, the first divided data generated by dividing the time-series data; and
storing, in the second storage unit, the second divided data generated by dividing the time-series data at a time that is different from a time at which the first divided data is divided.

3. The information processing system according to claim 2, further comprising:
a circular storage unit including a plurality of regions in which information is stored and which are arranged in a logically circulating formation, wherein
the procedure further including:
storing pieces of the time-series data in the consecutive regions in chronological order,
the storing in the first storage unit stores, when storing apiece of the time-series data in a region associated with the first storage unit from among the plurality of regions, in the first storage unit the first divided data generated by replicating pieces of data stored in the plurality of regions, and
the storing in the second storage unit stores, when storing apiece of the time-series data in a region associated with the second storage unit from among the plurality of regions, in the second storage unit the second divided data generated by replicating pieces of data stored in the plurality of regions.

4. The information processing system according to claim 3, wherein
the storing in the first storage unit stores, when storing a piece of data indicating a termination of the time-series data in any of the regions, in the first storage unit a piece of data that has not been stored in the first storage unit from among the pieces of data stored in the plurality of regions, and
the storing in the second storage unit stores, when the piece of data indicating the termination of the time-series data is stored in any of the regions, in the second storage unit a piece of data that has not been stored in the second storage unit from among the pieces of data stored in the plurality of regions.

5. The information processing system according to claim 2, the procedure further including:
in accordance with an importance of the time-series data, the storage processing unit storing in the third storage unit third divided data generated by diving the time-series data at a time that is different from the times at which the first divided data and the second divided data are divided; and
when a reproduction time is designated for the time-series data, reading and outputting divided data divided at a time just before the reproduction time from among the first divided data, the second divided data, and the third divided data stored in the first storage unit, the second storage unit, and the third storage unit.

6. A method for controlling an information processing system, the method comprising:
when a reproduction time is designated for time-series data, reading and outputting divided data divided at a time just before the reproduction time from among first divided data indicating the divided time-series data and stored in a first storage unit and second divided data stored in a second storage unit and indicating the divided time-series data divided at a time different from a time at which the first divided data is divided.

7. The method according to claim 6, the method further comprising:
storing, in the first storage unit, the first divided data generated by dividing the time-series data; and
storing, in the second storage unit, the second divided data generated by dividing the time-series data at a time different from a time at which the first divided data is divided.

8. The method according to claim 7, the method further comprising:
storing pieces of the time-series data in consecutive regions of a circular storage unit in chronological order, the circular storage unit including a plurality of regions arranged in a logically circulating formation for storage of information, wherein
the storing in the first storage unit stores, when a piece of the time-series data is stored in a region associated with the first storage unit from among the plurality of regions, in the first storage unit the first divided data generated by replicating pieces of data stored in the plurality of regions, and
the storing in the second storage unit stores, when a piece of the time-series data is stored in a region associated with the second storage unit from among the plurality of regions, in the second storage unit the second divided data generated by replicating pieces of data stored in the plurality of regions.

9. The method according to claim 8, wherein
the storing in the first storage unit stores, when a piece of data indicating a termination of the time-series data is stored in any of the regions, in the first storage unit a piece of data that has not been stored in the first storage unit from among the pieces of data stored in the plurality of regions, and
the storing in the second storage unit stores, when the piece of data indicating a termination of the time-series data is stored in any of the regions, in the second storage unit a piece of data that has not been stored in the second storage unit from among the pieces of data stored in the plurality of regions.

10. The method according to claim 7, the method further comprising:
in accordance with an importance of the time-series data, storing in a third storage unit third divided data generated by diving the time-series data at a time that is different from the times at which the first divided data and the second divided data are divided; and
when a reproduction time is designated for the time-series data, reading and outputting divided data divided at a time just before the reproduction time from among the first divided data, the second divided data, and the third divided data stored in the first storage unit, the second storage unit, and the third storage unit.

11. A non-transitory computer-readable recording medium having stored therein a program for causing a computer to execute a process, the process comprising:
when a reproduction time is designated for time-series data, reading and outputting divided data divided at a time just before the reproduction time from among first divided data indicating the divided time-series data and stored in a first storage unit and second divided data stored in a second storage unit and indicating the divided time-series data divided at a time different from a time at which the first divided data is divided.

12. The non-transitory computer-readable recording medium according to claim 11, wherein
the process further comprises
storing, in the first storage unit, the first divided data generated by dividing the time-series data, and
storing, in the second storage unit, the second divided data generated by dividing the time-series data at a time different from a time at which the first divided data is divided.

13. The non-transitory computer-readable recording medium according to claim 12, wherein
the process further comprises
storing pieces of the time-series data in consecutive regions of a circular storage unit in chronological order, the circular storage unit including a plurality of regions arranged in a logically circulating formation for storage of information, wherein
the storing in the first storage unit stores, when a piece of the time-series data is stored in a region associated with the first storage unit from among the plurality of regions, in the first storage unit the first divided data generated by replicating pieces of data stored in the plurality of regions, and
the storing in the second storage unit stores, when a piece of the time-series data is stored in a region associated with the second storage unit from among the plurality of regions, in the second storage unit the second divided data generated by replicating pieces of data stored in the plurality of regions.

14. The non-transitory computer-readable recording medium according to claim 13, wherein
the storing in the first storage unit stores, when a piece of data indicating a termination of the time-series data is stored in any of the regions, storing in the first storage unit a piece of data that has not been stored in the first storage unit from among the pieces of data stored in the plurality of regions, and
the storing in the second storage unit stores, when the piece of data indicating a termination of the time-series data is stored in any of the regions, in the second storage unit apiece of data that has not been stored in the second storage unit from among the pieces of data stored in the plurality of regions.

15. The non-transitory computer-readable recording medium according to claim 11, wherein
the process further comprises
in accordance with an importance of the time-series data, storing in a third storage unit third divided data generated by diving the time-series data at a time that is different from the times at which the first divided data and the second divided data are divided, and
when a reproduction time is designated for the time-series data, reading and outputting divided data divided at a time just before the reproduction time from among the first divided data, the second divided data, and the third divided data stored in the first storage unit, the second storage unit, and the third storage unit.
